(19) United States
(12) Patent Application Publication
(10) Pub. No.: US 2026/0037807 A1
(43) Pub. Date: Feb. 5, 2026

(54) NN GROWTH APPARATUS, INFORMATION PROCESSING APPARATUS, METHOD FOR PRODUCING NEURAL NETWORK INFORMATION, AND PROGRAM

(71) Applicant: SOFTBANK CORP., Tokyo (JP)

(72) Inventor: Yuko ISHIWAKA, Tokyo (JP)

(21) Appl. No.: 19/100,809

(22) PCT Filed: Aug. 31, 2022
(86) PCT No.: PCT/JP2022/032797

§ 371 Date: Feb. 3, 2025

(51) Int. Cl. G06N 3/082; G06N 3/10

(52) U.S. Cl. CPC G06N 3/082; G06N 3/10

(57) ABSTRACT

An NN growth apparatus includes: a start point storage in which pieces of firing start point information are stored, each piece of firing start point information containing an information identifier of feature information of image information and node identifiers; a goal storage in which pieces of goal information are stored, the pieces of goal information specifying goals respectively corresponding to states; a state determination unit that determines one state, using the sound information; a feature acquisition unit that acquires feature information from the image information; a firing node determination unit that determines node identifiers corresponding to the pieces of feature information from the start point storage unit, and determines a node identifier of a firing node connected to the nodes; and a growth unit that acquires the goal information paired with the one state, and performs processing to grow node information or edge information corresponding to node identifiers.

### TECHNICAL FIELD

The present invention relates to, for example, an NN growth apparatus, which is an apparatus that virtually realizes the mechanism of brain growth.

### BACKGROUND ART

Conventionally, there have been electroencephalogram signal processing apparatuses that acquire and process electroencephalogram signals that represent the electroencephalograms of a subject (see Patent Documents 1 and 2, for example).

### CITATION LIST

### Patent Documents

Patent Document 1: JP 2016-47239A

Patent Document 2: JP 2016-52430A

### SUMMARY OF INVENTION

### Technical Problem

However, the conventional techniques have not been able to simulate the development of an infant's brain.

### Solution to Problem

An NN growth apparatus according to a first aspect of the present invention is an NN growth apparatus including: an NN storage unit in which neural network information is stored, neural network information containing two or more pieces of node information each containing a node identifier, and one or more pieces of edge information each containing an edge identifier and specifying a connection between nodes; a start point storage unit in which one or more pieces of firing start point information are stored, each piece of firing start point information containing an information identifier that identifies feature information of sound information and one or more node identifiers that identify nodes that initially fire when the feature information is accepted; a goal storage unit in which pieces of goal information are stored, the pieces of goal information specifying goals respectively corresponding to two or more states that include positive and negative states; an information acceptance unit that accepts sound information and heart rate information; a state determination unit that determines one state from among the two or more states, using the heart rate information accepted by the information acceptance unit: a feature acquisition unit that acquires, using the sound information accepted by the information acceptance unit, one or more pieces of feature information corresponding to the sound information; a firing node determination unit that determines one or more node identifiers of one or more firing nodes corresponding to the one or more pieces of feature information acquired by the feature acquisition unit, from the start point storage unit, and determines a node identifier of a firing node that is connected to the one or more nodes identified by the one or more node identifiers by edges and to which the feature information is to be transferred; and a growth unit that acquires the goal information paired with the one state determined by the state determination unit, and, using the goal information, performs processing to grow node information or edge information corresponding to one or more node identifiers of the one or more node identifiers determined by the firing node determination unit.

With such a configuration, it is possible to realize an infant brain growth model for simulating infant brain growth.

An NN growth apparatus according to a second aspect of the present invention is the NN growth apparatus according to the first aspect of the invention, further including: a window determination unit that sequentially determines, from a still image contained in the image information accepted by the information acceptance unit, a sliding window, which is a partial region of the still image, wherein the feature acquisition unit uses a partial image corresponding to the sliding window sequentially determined by the window determination unit, to acquire one or more pieces of feature information corresponding to the partial image.

With such a configuration, it is possible to realize an infant brain growth model for more accurately simulating infant brain growth.

An NN growth apparatus according to a third aspect of the present invention is the NN growth apparatus according to the first or the second aspect of the invention, wherein the feature information contains an information identifier that identifies information and an information amount that indicates a size of the information, and the firing node determination unit judges whether or not one or more pieces of feature information transferred from one or more other nodes connected by edges satisfy one or more firing conditions related to the feature information, and determines the node identifier of a node judged to satisfy the firing conditions.

With such a configuration, it is possible to realize an infant brain growth model for simulating infant brain growth.

An NN growth apparatus according to a fourth aspect of the present invention is the NN growth apparatus according to any one of the first to third aspects of the invention, wherein the node information contains node position information that specifies a position of the node, the goal information contains goal position information that specifies a position of the goal, or goal direction information that indicates a direction of the goal, and the growth unit performs edge generation processing to generate and accumulate edge information for an edge extending from a node identified by one or more node identifiers of the one or more node identifiers determined by the firing node determination unit in the direction indicated by the goal information that is paired with the one state determined by the state determination unit.

With such a configuration, it is possible to realize an infant brain growth model for simulating infant brain growth.

An NN growth apparatus according to a fifth aspect of the present invention is the NN growth apparatus according to the fourth aspect of the invention, wherein the firing node determination unit accumulates count information related to a count of the determined node identifiers in association with the node identifiers, and the growth unit performs the edge generation processing on a node identified by a node identifier corresponding to the count information that matches an edge generation condition.

With such a configuration, it is possible to realize an infant brain growth model for simulating infant brain growth.

An NN growth apparatus according to a sixth aspect of the present

invention is the NN growth apparatus according to any one of the first to third aspects of the invention, wherein the node information contains node position information that specifies a position of the node, the goal information contains goal position information that specifies a position of the goal, or goal direction information that indicates a direction of the goal, and the growth unit performs edge growth processing to acquire and accumulate edge information in which an edge extending from one or more nodes identified by one or more node identifiers of the one or more node identifiers determined by the firing node determination unit is grown in a direction indicated by the goal information paired with the one state determined by the state determination unit.

With such a configuration, it is possible to realize an infant brain growth model for simulating infant brain growth.

An NN growth apparatus according to a seventh aspect of the present invention is the NN growth apparatus according to the sixth aspect of the invention, wherein the firing node determination unit accumulates count information related to a count of the determined node identifiers in association with the node identifiers, and the growth unit performs the edge growth processing on a node identified by a node identifier corresponding to the count information that matches an edge generation condition.

With such a configuration, it is possible to realize an infant brain growth model for simulating infant brain growth.

An NN growth apparatus according to an eighth aspect of the present invention is the NN growth apparatus according to any one of the first to seventh aspects of the invention, wherein each node is a soma, the edges include an axon and a dendrite, and the edge information contains axon information that contains an axon identifier and axon position information indicating a position of the axon, and dendrite information that contains a dendrite identifier and dendrite position information indicating a position of the dendrite.

With such a configuration, it is possible to realize an infant brain growth model for simulating infant brain growth.

An information processing apparatus according to a ninth aspect of the present invention is an information processing apparatus including: an NN storage unit in which neural network information accumulated by an NN growth apparatus is stored; an information acceptance unit that accepts acceptance information that is at least one of image information and sound information; a feature acquisition unit that acquires one or more pieces of feature information corresponding to the acceptance information accepted by the information acceptance unit: an information transfer unit that determines one or more node identifiers of one or more firing nodes, corresponding to the one or more pieces of feature information acquired by the feature acquisition unit, from a start point storage unit in which one or more pieces of firing start point information are stored, each piece of firing start point information containing an information identifier that identifies feature information of acceptance information and one or more node identifiers that identify nodes that initially fire when the feature information is accepted, and determines a node identifier of a firing node that is connected to the one or more nodes identified by the one or more node identifiers by edges and to which the feature information is to be transferred; a firing pattern acquisition unit that acquires a firing pattern using the one or more node identifiers determined by the information transfer unit; an output information acquisition unit that acquires output information corresponding to the firing pattern acquired by the firing pattern acquisition unit; and an information output unit that outputs the output information.

With such a configuration, it is possible to simulate the operation of the grown brain of an infant.

An information processing apparatus according to a tenth aspect of the present invention is the ninth aspect of the invention, further including: a temperature acceptance unit that accepts temperature information, wherein the information transfer unit performs information transfer processing to transfer, from a node that has fired, the feature information corresponding to the node that has fired, to a node that is to fire next, and changes a processing time for the information transfer processing based on the temperature information accepted by the temperature acceptance unit.

With such a configuration, it is possible to simulate operation of a baby's developing brain to be simulated.

### Advantageous Effects of Invention

The NN growth apparatus according to the present invention can simulate infant brain growth.

### BRIEF DESCRIPTION OF DRAWINGS

FIG. 1 is a block diagram of an NN growth apparatus 1 according to a first embodiment.

FIG. 2 is a flowchart illustrating examples of operations of the NN growth apparatus 1 according to the same.

FIG. 3 is a flowchart illustrating an example of growth processing according to the same.

FIG. 4 is a flowchart illustrating an example of single node processing according to the same.

FIG. 5 is a flowchart illustrating an example of node generation processing according to the same.

FIG. 6 is a flowchart illustrating an example of node information generation processing according to the same.

FIG. 7 is a flowchart illustrating an example of edge generation processing according to the same.

FIG. 8 is a flowchart illustrating an example of edge information generation processing according to the same.

FIG. 9 is a flowchart illustrating an example of edge growth processing according to the same.

FIG. 10 is a flowchart illustrating an example of edge extension processing according to the same.

FIG. 11 is a flowchart illustrating an example of firing transfer processing according to the same.

FIG. 12 is a flowchart illustrating an example of firing judgment processing according to the same.

FIG. 13 is a second block diagram of the NN growth apparatus 1 according to the same.

FIG. 14 is a flowchart illustrating second examples of operations of the NN growth apparatus 1 according to the same.

FIG. 15 is a flowchart illustrating an example of window determination processing according to the same.

FIG. 16 is a block diagram of an information processing apparatus 2 according to a second embodiment.

FIG. 17 is a flowchart illustrating examples of operations of the information processing apparatus 2 according to the same.

FIG. 18 is a flowchart illustrating an example of information transfer processing according to the same.

FIG. 19 is a flowchart illustrating an example of subsequent transfer processing according to the same.

FIG. 20 is a flowchart illustrating an example of firing judgment processing according to the same.

FIG. 21 is a block diagram of an information processing apparatus 3 according to the same.

FIG. 22 is an overview diagram of a computer system according to the above embodiments.

FIG. 23 is a block diagram of the computer system according to the same.

### DESCRIPTION OF EMBODIMENTS

Hereinafter, embodiments of an NN growth apparatus and so on will be described with reference to the drawings. Note that in the embodiments, constituent elements with the same reference signs perform similar operations, and therefore, repeated descriptions thereof may be omitted.

### First Embodiment

The present embodiment describes an NN growth apparatus that

accepts image information and sound information, uses the sound information to judge a state such as a positive state or a negative state, detects a node that fires based on one or more pieces of feature information acquired from the image information, depending on the result of the judgment, and performs growth processing corresponding to the node. Note that examples of growth processing include edge generation processing, edge growth processing, and node generation processing.

Edge generation processing is processing performed to generate edges that are to be included in a neural network (hereinafter referred to as “NN” where applicable). Edge growth processing is processing performed to grow the edges that are to be included in the NN. Node generation processing is processing performed to generate nodes that are to be included in the NN. It is preferable that the neural network here is a spiking neural network. However, the neural network may be a different type of neural network, such as a deep neural network. That is to say, there is no limitation on the type of neural network.

In this specification, the state in which information X is associated with information Y means that the information Y can be acquired from the information X or the information X can be acquired from the information Y, and there is no limitation on the method for associating the information. The information X and the information Y may be linked to each other or in the same buffer. The information X may be contained in the information Y, or the information Y may be contained in the information X, for example.

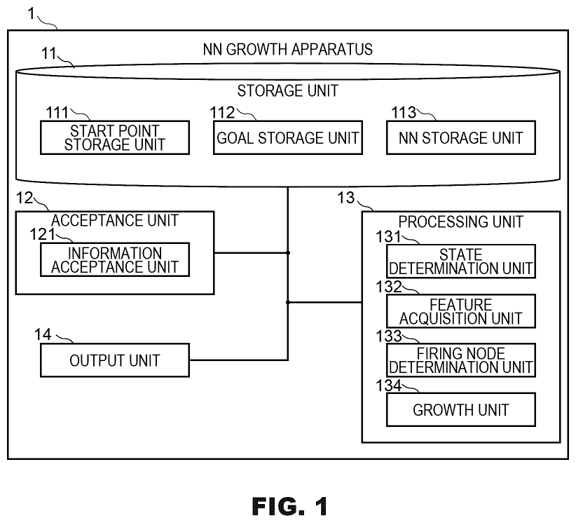

FIG. 1 is a block diagram of an NN growth apparatus 1 according to the present embodiment. The NN growth apparatus 1 includes a storage unit 11, an acceptance unit 12, a processing unit 13, and an output unit 14. The storage unit 11 includes a start point storage unit 111, a goal storage unit 112, and an NN storage unit 113. The acceptance unit 12 includes an information acceptance unit 121. The processing unit 13 includes a state determination unit 131, a feature acquisition unit 132, a firing node determination unit 133, and a growth unit 134.

The storage unit 11 included in the NN growth apparatus 1 stores various kinds of information. Examples of the various kinds of information include firing start point information, which will be described later, goal information, which will be described later, a neural network (NN), one or more pieces of glial cell information, which will be described later, one or more pieces of connection information, which will be described later, one or more pieces of firing information, which will be described later, and state determination information, which will be described later.

The start point storage unit 111 stores one or more pieces of firing start point information. The start point storage unit 111 typically stores two or more pieces of firing start point information.

The firing start point information is information that specifies a node that fires in the first stage when image information is accepted. The node that fires in the first stage is a node that fires without the intervention of another node. The firing start point information contains an information identifier and one or more node identifiers. The firing start point information may include an initial firing condition and one or more node identifiers.

The information identifier is information that identifies the feature information of the image information. The information identifier is information that specifies the type of image feature. The information identifier indicates, for example, “R”, “G”, or “B”. “R” is information indicating the color red, “G” is information indicating the color green, and “B” is information indicating the color blue.

The initial firing condition is a condition for a node to fire in the first stage. The initial firing condition is a condition related to the information identifier. The initial firing condition typically includes an information identifier. The initial firing condition is, for example, a condition related to an information identifier and an information amount. The initial firing condition is, for example, “<information identifier>R<condition>information amount>=150”. The initial firing condition is, for example, “information amount of “R”>=150”, “(information amount of “R”>=150) & (information amount of “G”>=80)”, or “(information amount of “R”>=150) & (information amount of “G”>=80) & (information amount of “B”>=120)”.

Each node identifier is, for example, information that identifies a node that is included in the NN. Each node identifier is, for example, a node ID or a node name. Each node may be referred to as a soma. Node identifiers may be referred to as soma identifiers

The feature information here is a feature of image information. The feature information is, for example, an information identifier, or an information identifier and an information amount. The information identifier is information that identifies feature information. The information amount is information that indicates the size of the information identified by the information identifier paired therewith. The feature information is, for example, “<information identifier>R<information amount>150”.

The goal storage unit 112 stores one or more pieces of goal information. The goal storage unit 112 typically stores two or more pieces of goal information.

The goal information is information that specifies the goal to which a node or an edge included in the NN grows. The goal information is information that specifies a goal corresponding to one state of two or more states. The state is, for example, an emotion or an internal state of the brain. The state is, for example, positive or negative. It is preferable that each type of state is either positive or negative. However, there may be three or more types of states. If there are three or more types of states, each state is, for example, information indicating any one of two or more degrees of positive state, or information indicating any one of two or more degrees of negative state.

The goal information can be said to be information that specifies a position to which a node or edge will grow. The goal information contains goal position information or goal direction information. The goal information corresponds to a state identifier. The goal position information is information that specifies the position of the goal. The goal direction information indicates the direction of the goal. The position is a position in a virtual space of two or more dimensions. The goal information is, for example, position information. The position information is, for example, three-dimensional coordinate values (x,y,z), two-dimensional coordinate values (x,y), or a four-dimensional quaternion (x,y,x, w). In addition, the fact that the goal information corresponds to the state identifier means that the goal information corresponding to the determined state identifier is used for the growth of the NN.

The NN storage unit 113 stores neural network information (hereinafter referred to as “NN information” where appropriate). The NN information can be said to be information that mimics the brain. The NN information contains two or more pieces of node information and one or more pieces of edge information. NN information may also be referred to as “NN”.

The node information is information regarding the nodes included in the NN. The node information contains a node identifier. The node information contains, for example, node position information, a firing condition, firing probability information, and count information. It is also preferable that the node information contains information necessary energy amount information that indicates the amount of energy necessary for firing.

The node position information is position information regarding a node.

As described above, the position information is, for example, three-dimensional coordinate values (x,y,z), two-dimensional coordinate values (x,y), or a four-dimensional quaternion (x,y,x, w).

The firing condition is a condition for a node to fire. The firing condition

typically includes one or more pieces of feature information. The feature information may be information that includes an information identifier that identifies information and an information amount that indicates the size of the information, or may be information that only includes an information amount that indicates the size of the information. The information amount is, for example, a numerical value greater than zero. The firing condition is, for example, “R>=180”, “R>150 & G>=100”, “G<=50 & B<=30”, “R>=250 & G>=250 & B>=250”, or the like.

The firing probability information is information regarding the probability of firing. The firing probability information may be the firing probability itself, or may be a value obtained by converting the firing probability using a function or the like. It is preferable that the firing probability information is referenced, and the node may or may not fire at the probability indicated by the firing probability information even if the feature information is the same.

The count information is information based on the number of times the node has fired. The count information is, for example, the number of firings or the frequency of firings (firing rate).

Each piece of edge information is information regarding edges included in the NN. Each piece of edge information is information that specifies connections between nodes. Each piece of edge information typically contains an edge identifier. Each piece of edge information contains, for example, the node identifiers of the two nodes that the edge connects. Each piece of edge information contains, for example, one node identifier of a node to which the edge connects. If a piece of edge information contains only one node identifier, the edge is a growing edge before connecting two nodes. Each piece of edge information contains, for example, edge position information. The edge position information is information that specifies the position of an end point of the edge. It is preferable that each piece of edge information contains retained energy amount information that indicates the amount of energy stored in the edge.

Each piece of edge information contains, for example, dendrite information and axon information. In such a case, each edge contains a dendrite and an axon. Note that each edge may be considered to be a single line, or a line having two or more branches. Note that edges may be referred to as synapses.

Each edge identifier is information that identifies the edge. Each edge identifier is, for example, an edge ID or an edge name.

The dendrite information is information regarding dendrites. Dendrites are parts of nerve cells. Dendrites are multiple projections that branch out from a cell body like the branches of a tree to receive external stimuli and information sent out by the axons of other neurons. The dendrites here are elements that are included in the edges. Each piece of dendrite information contains a dendrite identifier and dendrite position information.

Each dendrite identifier is information that identifies a dendrite. Each dendrite identifier is, for example, a dendrite ID or a dendrite name.

The dendrite position information is information regarding the positions of the dendrites. The dendrite position information is information that specifies the positions of the dendrites, and is, for example, one or more sets of three-dimensional coordinate values (x,y,z) or one or more sets of two-dimensional coordinate values (x,y). When a piece of dendrite position information contains two or more sets of coordinate values, the dendrite is a line connecting the points indicated by the two or more coordinate values.

It is preferable that each piece of dendrite information contains retained energy amount information that indicates the amount of energy stored in the dendrite. It is also preferable that each piece of dendrite information contains necessary energy amount information that indicates the amount of energy required to transfer information using the dendrite.

Axon information is information regarding axons. Axons are protrusion structures extending from a cell body and are responsible for outputting signals in nerve cells. The axons here are elements that are included in the edges. Each piece of axon information contains an axon identifier and axon position information.

Each axon identifier is information that identifies an axon. Each axon identifier is, for example, an axon ID or an AXON name.

Each axon position information is position information indicating the position of the axon. The axon position information is information that specifies the positions of the axons, and is, for example, one or more sets of three-dimensional coordinate values (x,y,z) or one or more sets of two-dimensional coordinate values (x,y). When a piece of axon position information contains two or more sets of coordinate values, the axon is a line connecting the points indicated by the two or more coordinate values.

It is preferable that each piece of axon information contains retained energy amount information that indicates the amount of energy stored in the axon. It is also preferable that each piece of axon information contains necessary energy amount information that indicates the amount of energy required to transfer information using the axon.

Note that dendrites and axons may be branched. When dendrites and axons are branched, the position information of each can be expressed by three or more sets of coordinate values. However, there is no limitation on the method of expressing dendrite position information and axon position information.

The glial cell information stored in the storage unit 11 is information regarding glial cells. Note that the glial cell information does not have to be stored in the storage unit 11.

Here, glial cells are also called neuroglial cells, which is a general term for non-neuronal cells that are included in the nervous system. Glial cells are a glue- or cement-like substance that fills the spaces between neurons.

It is preferable that each piece of glial cell information contains a glial cell identifier that identifies the glial cell. Each piece of glial cell information may contain, for example, a node identifier that identifies a node that supports the connection, or an edge identifier that identifies an edge that supports the connection. Each piece of glial cell information may contain, for example, an axon identifier of an axon whose connection is assisted by the glial cell, or a dendrite identifier of a dendrite whose connection is assisted by the glial cell. Each piece of glial cell information may also contain a glial cell type identifier that identifies the type of glial cell. Types of glial cells include, for example, an oligodendrocite (hereinafter referred to as an “oligo” when appropriate) and an astrocite. Note that an oligo is a cell that can be connected to an axon. An astrocite is a cell that can be connected to a soma or a dendrite. It is preferable that each piece of glial cell information contains glial cell position information. The glial cell position information is position information that specifies the position of the glial cell. In particular, it is preferable that glial cell information of an oligo contains glial cell position information. In addition, each piece of glial cell information may also contain hand length information indicating the length of each of one or more hands. In addition, each piece of glial cell information may contain hand number information indicating the number of hands extending from the glial cell. Typically, it is preferable that a glial cell does not grow any further when the total hand length of the glial cell calculated from the hand length information of each hand reaches a threshold value.

Each piece of connection information stored in the storage unit 11 is information that specifies a connection between two or more nodes. Each piece of connection information may be information that specifies a connection between an axon of one node and a dendrite of another node. Such information is also information that specifies connections between nodes. Each piece of connection information may be information that specifies a connection between one synapse and one spine. Such information is also information that specifies connections between nodes. Each piece of connection information contains, for example, node identifiers of two nodes that are connected. In addition, each piece of connection information contains, for example, the axon identifier of an axon and the dendrite identifier of a dendrite that is connected to the axon. In addition, each piece of connection information contains, for example, the synapse identifier of a synapse and the spine identifier of a spine that can transfer information to and from the synapse. Each piece of connection information may contain information transfer probability information. The information transfer probability information is information regarding the probability of information transfer between one node and another node. The information transfer probability information may be information regarding the probability of information transfer between an axon and a dendrite. Even in such a case, the information transfer probability information is information regarding the probability of information transfer between one node and another node. In addition, the information transfer probability information may be information regarding the probability of information transfer between a synapse and a spine. Even in such a case, the information transfer probability information is information regarding the probability of information transfer between one node and another node. Note that the connection direction between nodes here is typically unidirectional.

Each piece of connection information may be information indicating a connection between a node and an axon. In such a case, each piece of connection information contains a node identifier and an axon identifier. In addition, each piece of connection information may be information indicating the connection between a node and a dendrite. In such a case, each piece of connection information contains a node identifier and a dendrite identifier.

Each piece of connection information may be information that specifies a connection between a glial cell an axon or a dendrite. In such a case, each piece of connection information contain, for example, a glial cell identifier that identifies glial cell information and an axon identifier. Each piece of connection information may contain, for example, a glial cell identifier and a dendrite identifier.

Note that the connection information that specifies connections between the elements (nodes, edges, axons, dendrites, glial cells, synapses, or spines) included in the NN may be stored in the NN storage unit 113. That is to say, the connection information that specifies connections between the elements included in the NN may be contained in information regarding each element.

The firing information is information regarding the result of firing. The firing information contains a node identifier that identifies the node that has fired. The firing information may typically contain timer information indicating when firing occurred. The timer information may be information indicating a relative time, or time information indicating an absolute time. Note that the firing information may be automatically deleted by the processing unit 13 when a certain period of time has elapsed since its accumulation.

The state determination information is information for determining one state using sound information. The state determination information is, for example, two or more sets each containing a sound condition, which is a condition related to the sound information, and a state identifier. The state determination information indicates, for example, “<sound condition>information amount of information identifier “frequency =X”>=50<state identifier>state P”, “<sound condition>information amount of information identifier “frequency =X”>=80<state identifier>state N”, “<sound condition>information amount of information identifier “frequency=Y”>=50 & information amount of information identifier “frequency =Z”>=90<state identifier>state P”.

The acceptance unit 12 accepts various kinds of information. Example of the various kinds of information include image information and sound information.

The “acceptance” here is a concept that includes, for example, acceptance of information input from an input device such as a camera, reception of information transmitted via a wired or wireless communication network, or acceptance of information read out from a recording medium such as an optical disk, a magnetic disk, or a semiconductor memory.

The information acceptance unit 121 acquires, for example, image information acquired by a camera. The information acceptance unit 121 acquires, for example, sound information acquired by a microphone. That is to say, the “acceptance” is acceptance of information acquired by a device such as a microphone or a camera, but may be a concept that includes reception of information transmitted via a wired or wireless communication network, acceptance of information read out from a recording medium such as an optical disk, a magnetic disk, or a semiconductor memory, and so on.

The information acceptance unit 121 accepts image information and sound information. The information acceptance unit 121 accepts, for example, image information and sound information at the same time. However, for example, there may be some delay in the reception of image information and sound information by the information acceptance unit 121. The image information is a still image or a moving image. The sound information is, for example, voice data or music data, but the sound information need only be information regarding sound, and there is no limitation on the type thereof.

The processing unit 13 performs various kinds of processing. The various kinds of processing are, for example, the processing performed by the state determination unit 131, the feature acquisition unit 132, the firing node determination unit 133, and the growth unit 134.

The state determination unit 131 determines one state from among two or more states, using the sound information accepted by the information acceptance unit 121. The state may be, for example, either a “positive” state (also referred to as a state P where appropriate) or a “negative” state (also referred to as a state N where appropriate). Determining the state is, for example, acquiring a state identifier. The state identifier is information that identifies the state. The state identifier is, for example, the “state P” or the “state N”.

Here, each piece of feature information contains, for example, an information identifier and an information amount. For example, the state determination unit 131 analyzes the sound information, which is the accepted voice, and acquires one or more pieces of feature information for the voice. The feature acquisition unit 132 performs voice analysis on the accepted sound information, and acquires, for example, “information identifier (frequency=X), information amount=50”, “information identifier (frequency=Y), information amount=120”, and the like. Note that such information shows levels at the respective frequencies.

Determining the state is, for example, acquiring a state identifier. The state identifier is information that identifies the state. The state identifier is, for example, the “state P” or the “state N”. Note that determining the state is typically acquiring a state identifier.

The state determination unit 131 determines a sound condition, which is a condition related to the sound information accepted by the information acceptance unit 121, from the sound conditions included in two or more pieces of state determination information, and acquires a state identifier paired with the sound condition.

For example, the state determination unit 131 uses the sound information accepted by the information acceptance unit 121 to acquire one or more pieces of feature information corresponding to the sound information. Next, the state determination unit 131 acquires, for example, one state identifier that is paired with a sound condition that is satisfied by one or more pieces of feature information for the sound information.

The state determination unit 131 determines one state based on sound information, using state determination information, for example. The state determination unit 131 acquires, for example, a state identifier that is paired with a sound condition that matches one or more pieces of feature information for the sound information.

Note that the processing in which one or more pieces of feature information are acquired from the sound information may be performed by the feature acquisition unit 132.

The feature acquisition unit 132 uses the sound information accepted by the information acceptance unit 121 to acquire one or more pieces of feature information corresponding to the sound information.

Here, each piece of feature information contains, for example, an information identifier and an information amount. The feature acquisition unit 132, for example, analyzes the accepted image information and acquires one or more pieces of feature information of the image information. The feature acquisition unit 132 acquires, for example, the information amount of the information identifier “R”, the information amount of the information identifier “G”, and the information amount of the information identifier “B” from the accepted image information.

The information amount of the information identifier “R” is information regarding the amount of information of “R” in the region of interest of an image. The information amount of the information identifier “R” is, for example, a representative value of the R values of one or more pixels in the region of interest of an image. The information amount of the information identifier “R” is, for example, the number or percentage of pixels whose R value is equal to or greater than a threshold value among one or more pixels in a region of interest of an image.

The information amount of the information identifier “G” is information regarding the amount of information of “G” in the region of interest of the image. The information amount of the information identifier “G” is, for example, a representative value of the G values of one or more pixels in the region of interest of an image. The information amount of the information identifier “G” is, for example, the number or percentage of pixels whose G value is equal to or greater than a threshold value among one or more pixels in a region of interest of an image.

The information amount of the information identifier “B” is information regarding the amount of information of “B” in the region of interest of the image. The information amount of the information identifier “B” is, for example, a representative value of the B values of one or more pixels in the region of interest of an image. The information amount of the information identifier “B” is, for example, the number or percentage of pixels whose B value is equal to or greater than a threshold value among one or more pixels in a region of interest of an image.

Note that the region of interest in an image is a window determined by the window determination unit 130, which will be described later, but may be the entire image information.

The representative value is, for example, the average value, but may also be the median value or the like.

The feature acquisition unit 132 may acquire one or more pieces of feature information for one piece of image information accepted by the information acceptance unit 121, or may acquire one or more pieces of feature information for two or more pieces of image information (moving images) that are consecutive in time.

For example, the feature acquisition unit 132 uses one piece of image information and one piece of image information that precedes the one piece of image information to acquire the amount of movement between the two pieces of image information. Such an amount of movement is an example of feature information of the moving images acquired by the feature acquisition unit 132.

The feature acquisition unit 132 may acquire, for example, a first movement amount, which is the amount of movement between first image information and second image information immediately preceding the first image information, a second movement amount, which is the amount of movement between the first image information and second image information that is two images before the first image information, and an N^{th} movement amount, which is the amount of movement between the first image information and N^{th} image information that is N images before the first image information, and form a movement amount vector (first movement amount, second movement amount, . . . , N^{th} movement amount). Such a movement amount vector is also an example of feature information of the moving images acquired by the feature acquisition unit 132.

The movement amount between images is information that specifies the amount of movement between two images. The movement amount is, for example, a motion vector or an optical flow.

The firing node determination unit 133 determines, from the start point storage unit 111, node identifiers corresponding to the one or more pieces of feature information acquired by the feature acquisition unit 132, which are the node identifiers of firing nodes that are to fire. Next, the firing node determination unit 133 determines the node identifier of a node that is connected to each of the one or more firing nodes by edges to receive the feature information from the firing node, and that is to fire. Note that the node identifiers of the firing nodes are referred to as the firing node identifiers where appropriate.

For example, the firing node determination unit 133 judges whether or not one or more pieces of feature information transferred from one or more other nodes connected by edges satisfy a firing condition, and determines the node identifier of a node judged to satisfy the firing condition. Note that the firing condition is a condition related to one or more pieces of feature information.

It is preferable that the firing node determination unit 133 accumulates count information related to the count of the determined node identifiers in association with the node identifiers. The count information is information based on the number of firings, and is, for example, the number of firings, or the frequency of firings (firing rate).

The growth unit 134 performs growth processing. Here, the growth unit 134 performs growth processing for growing an NN that mimics the infant's brain. The growth unit 134 performs NN growth processing using the accepted image information and sound information. The growth unit 134 performs processing to grow the nodes or edges, or the nodes and edges, that are to be included in the NN, using one or more pieces of feature information acquired from the accepted image information and one or more pieces of feature information acquired from the sound information.

More specifically, the growth unit 134 acquires goal information that is paired with one state determined by the state determination unit 131, and performs processing to grow node information or edge information corresponding to one or more node identifiers of the one or more node identifiers determined by the firing node determination unit 133, using the goal information.

For example, the growth unit 134 acquires goal information paired with the state identifier of the one state determined by the state determination unit 131, and performs processing to grow node information or edge information corresponding to one or more firing node identifiers that satisfy a growth condition of the one or more node identifiers determined by the firing node determination unit 133, using the acquired goal information. Note that the node identifiers that satisfy the growth condition are node identifiers that identify pieces of node information that satisfy the growth condition.

For example, the growth unit 134 performs processing to grow the node information or edge information corresponding to all of the node identifiers of the one or more node identifiers determined by the firing node determination unit 133, using the goal information.

In addition, the growth processing performed using the acquired goal information is, for example, processing performed to extend an edge connected to a node identified by a firing node identifier in the direction of the position indicated by the goal position information contained in the acquired goal information. The growth processing performed using the acquired goal information is, for example, processing performed to extend an edge connected to a node identified by a firing node identifier in the direction indicated by the goal direction information contained in the acquired goal information. Note that the processing performed to extend an edge typically involves changing the position of the edge position information contained in the edge information to a position away from the connected node. The processing performed to extend an edge usually typically involves moving the position of the edge position information contained in the edge information to a position that is closer to the position of the goal position information contained in the goal information.

The growth condition is a condition for growth. The growth condition is, for example, a condition based on count information. For example, the growth condition is “the number of firings is equal to or greater than a threshold value”, “the number of firings is greater than a threshold value”, “the firing frequency is equal to or greater than a threshold value”, or “the firing frequency is greater than a threshold value”.

Note that growth processing is, for example, edge generation processing, which will be described later, edge growth processing, which will be described later, or node generation processing, which will be described later. Hereinafter, each type of growth processing will be described in detail.

### (1) Edge Generation Processing

The growth unit 134 performs, for example, edge generation processing. The edge generation processing can be said to be processing performed to generate new edges. The edge generation processing is processing performed to generate new edge information and accumulate it in the NN storage unit 113. That is to say, the growth unit 134 generates and accumulates edge information for an edge extending from one or more nodes identified by one or more node identifiers among the one or more node identifiers determined by the firing node determination unit 133 at a position in the direction indicated by the goal information that is paired with the one state determined by the state determination unit 131.

It is preferable that the one or more node identifiers of the one or more node identifiers determined by the firing node determination unit 133 are one or more node identifiers that match the edge generation condition of the one or more node identifiers determined by the firing node determination unit 133. However, one or more node identifiers of the one or more node identifiers determined by the firing node determination unit 133 may be all of the node identifiers determined by the firing node determination unit 133.

Note that the processing performed to generate edge information is processing performed to generate edge information regarding an edge connected to a node identified by a target node identifier. The processing performed to generate edge information is, for example, processing performed to acquire a unique edge identifier, and generate edge information that contains an edge identifier, which is information regarding an edge that connects a node identified by the target node identifier to another node in the direction indicated by the goal information from the node. Such edge information contains, for example, the node identifiers of the two nodes that are to be connected to the edge identifier. The processing performed to generate edge information is, for example, processing performed to acquire a unique edge identifier, acquire edge position information that specifies the position of the end point of the edge extending from the node identified by the target node identifier in the direction from the node indicated by the goal information, and generate edge information that contains the edge position information. Such edge information contains, for example, an edge identifier, a node identifier of a target (connecting) node, and edge position information that specifies the position of the end point of the edge.

The edge generation condition is a condition for generating an edge. The edge generation condition is, for example, a condition based on count information. For example, the edge generation condition is “the number of firings is equal to or greater than a threshold value”, “the number of firings is greater than a threshold value”, “the firing frequency is equal to or greater than a threshold value”, or “the firing frequency is greater than a threshold value”. The edge generation condition may be the same as or different from the growth condition. In addition, the edge generation condition may be common to all nodes of interest, may be different for each node, or may be different for each edge. When the edge generation condition is different for each node, the node information contains the edge generation condition, for example. When the edge generation condition is different for each edge, the edge information contains the edge generation condition, for example.

It is preferable that the growth unit 134 performs edge generation processing on a node identified by a node identifier corresponding to the count information that matches the edge generation condition.

Note that the edge generation processing may be one or more of dendrite generation processing, which will be described later, and axon generation processing, which will be described later. In addition, the edge generation processing may include glial cell generation processing, which will be described later.

### (1-1) Dendrite Generation Processing

The growth unit 134 performs, for example, dendrite generation processing. The dendrite generation processing is processing performed to generate a new dendrite. The edge generation processing may include processing performed to generate new dendrite information and accumulate it in the NN storage unit 113. That is to say, the growth unit 134 generates and accumulates dendrite information for a dendrite extending from one or more nodes identified by one or more node identifiers among the one or more node identifiers determined by the firing node determination unit 133 in a direction indicated by the goal information that is paired with the one state determined by the state determination unit 131, for example.

It is preferable that the one or more node identifiers of the one or more node identifiers determined by the firing node determination unit 133 are one or more node identifiers that match the dendrite generation condition of the one or more node identifiers determined by the firing node determination unit 133. However, one or more node identifiers of the one or more node identifiers determined by the firing node determination unit 133 may be all of the node identifiers determined by the firing node determination unit 133.

Note that the processing performed to generate dendrite information is processing performed to generate dendrite information regarding the dendrite connected to the node identified by the target node identifier. The processing performed to generate dendrite information is, for example, processing performed to acquire a unique dendrite identifier, acquire dendrite position information that specifies the dendrite extending from the node identified by the target node identifier (the node identifier of the node to which the dendrite is connected) in the direction indicated by the goal information, and form and accumulate dendrite information that contains the dendrite identifier and the dendrite position information.

The dendrite generation condition is a condition for generating a dendrite. The dendrite generation condition is, for example, a condition based on count information. For example, the edge generation condition is “the number of firings is equal to or greater than a threshold value”, “the number of firings is greater than a threshold value”, “the firing frequency is equal to or greater than a threshold value”, or “the firing frequency is greater than a threshold value”. The dendrite generation condition may be the same as or different from the growth condition.

### (1-2) Axon Generation Processing

The growth unit 134 performs, for example, axon generation processing. The axon generation processing is processing performed to generate a new axon. The edge generation processing may include processing performed to generate new axon information and accumulate it in the NN storage unit 113. That is to say, the growth unit 134 generates and accumulates axon information for an axon extending from one or more nodes identified by one or more node identifiers among the one or more node identifiers determined by the firing node determination unit 133 in a direction indicated by the goal information that is paired with the one state determined by the state determination unit 131, for example.

It is preferable that the one or more node identifiers of the one or more node identifiers determined by the firing node determination unit 133 are one or more node identifiers that match the axon generation condition of the one or more node identifiers determined by the firing node determination unit 133. However, one or more node identifiers of the one or more node identifiers determined by the firing node determination unit 133 may be all of the node identifiers determined by the firing node determination unit 133.

Note that the processing performed to generate axon information is processing performed to generate axon information regarding the axon connected to the node identified by the target node identifier (the node identifier of the node to which the axon is connected). The processing performed to generate axon information is, for example, processing performed to acquire a unique axon identifier, acquire axon position information that specifies the position of the axon extending from the node identified by the target node identifier in the direction indicated by the goal information, and form and accumulate axon information that contains the axon identifier and the axon position information.

The axon generation condition is a condition for generating an axon. The axon generation condition is, for example, a condition based on count information. For example, the edge generation condition is “the number of firings is equal to or greater than a threshold value”, “the number of firings is greater than a threshold value”, “the firing frequency is equal to or greater than a threshold value”, or “the firing frequency is greater than a threshold value”. The axon generation condition may be the same as or different from the growth condition.

### (2) Edge Growth Processing

The growth unit 134 performs, for example, edge growth processing. The edge growth processing is processing performed to grow an edge. The processing performed to grow an edge is typically processing performed to increase the length of the edge. The processing performed to grow an edge may be processing performed to connect the edge from the node from which the edge originates to another node. For example, the growth unit 134 performs edge growth processing to acquire and accumulate edge information in which an edge extending from one or more nodes identified by one or more node identifiers among the one or more node identifiers determined by the firing node determination unit 133 is grown in a direction indicated by the goal information paired with the one state determined by the state determination unit 131.

It is preferable that the one or more node identifiers of the one or more node identifiers determined by the firing node determination unit 133 are the node identifiers of one or more nodes that match the edge growth condition of the one or more node identifiers determined by the firing node determination unit 133. However, one or more node identifiers of the one or more node identifiers determined by the firing node determination unit 133 may be all of the node identifiers determined by the firing node determination unit 133.

Note that acquiring edge information in which an edge extending from a node is grown means changing the edge position information contained in the edge information to position information in which the end point of the edge indicated by the edge position information is located further away from the node.

The edge growth condition is a condition for performing edge growth processing. The edge growth condition is, for example, a condition based on count information. For example, the edge growth condition is “the number of firings is equal to or greater than a threshold value”, “the number of firings is greater than a threshold value”, “the firing frequency is equal to or greater than a threshold value”, or “the firing frequency is greater than a threshold value”. The edge growth condition may be the same as or different from the growth condition. In addition, the edge growth condition may be common to all nodes of interest, may be different for each node, or may be different for each edge. When the edge growth condition is different for each node, the node information contains the edge growth condition, for example. When the edge growth condition is different for each edge, the edge information contains the edge growth condition, for example.

The processing performed to grow an edge extending from a node is processing performed to further acquire position information that specifies the position in the direction indicated by the goal information from the edge position information contained in the edge information that contains the node identifier that identifies the node, and to set the position information as the edge position information.

Note that the edge growth processing may be one or more of dendrite growth processing, which will be described later, and axon growth processing, which will be described later.

### (2-1) Dendrite Growth Processing

The growth unit 134 performs, for example, dendrite growth processing. The dendrite growth processing is processing performed to grow a dendrite. The dendrite growth processing may be included in edge growth processing. The processing performed to grow a dendrite is typically processing performed to increase the length of the dendrite. The processing performed to grow a dendrite is processing performed to acquire new dendrite position information in which the position of the end point indicated by the dendrite position information contained in the dendrite information of the dendrite is away from the position of the connected node, and to accumulate the new dendrite position information.

For example, the growth unit 134 performs dendrite growth processing to generate and accumulate dendrite information in which a dendrite is grown, the dendrite extending from one or more nodes identified by one or more node identifiers among the one or more node identifiers determined by the firing node determination unit 133 in a direction indicated by the goal information that is paired with the one state determined by the state determination unit 131.

It is preferable that the one or more node identifiers of the one or more node identifiers determined by the firing node determination unit 133 are the node identifiers of one or more nodes that match the dendrite growth condition of the one or more node identifiers determined by the firing node determination unit 133. However, one or more node identifiers of the one or more node identifiers determined by the firing node determination unit 133 may be all of the node identifiers determined by the firing node determination unit 133.

Note that acquiring dendrite information in which a dendrite extending from a node is grown means changing the dendrite position information contained in the dendrite information to position information in which the end point of the dendrite indicated by the dendrite position information is located further away from the node.

The dendrite growth condition is a condition for performing dendrite growth processing. The dendrite growth condition is, for example, a condition based on count information. For example, the dendrite growth condition is “the number of firings is equal to or greater than a threshold value”, “the number of firings is greater than a threshold value”, “the firing frequency is equal to or greater than a threshold value”, or “the firing frequency is greater than a threshold value”. The dendrite growth condition may be the same as or different from the growth condition.

In addition, the processing performed to grow a dendrite extending from a node is processing performed to further acquire position information that specifies a position in the direction indicated by the goal information from the dendrite position information contained in the dendrite information that is paired with the node identifier that identifies the node, and to set the position information as the dendrite position information.

### (2-2) Axon Growth Processing

The growth unit 134 performs, for example, axon growth processing. The axon growth processing is processing performed to grow an axon. The axon growth processing may be included in the edge growth processing. The processing performed to grow an axon is typically processing performed to increase the length of the axon. The processing performed to grow an axon is processing performed to acquire new axon position information in which the position of the end point indicated by the axon position information contained in the axon information of the axon is away from the position of the connected node, and to accumulate the new axon position information.

For example, the growth unit 134 performs axon growth processing to acquire and accumulate axon information in which an axon is grown, the axon extending from one or more nodes identified by one or more node identifiers among the one or more node identifiers determined by the firing node determination unit 133 in a direction indicated by the goal information that is paired with the one state determined by the state determination unit 131.

It is preferable that the one or more node identifiers of the one or more node identifiers determined by the firing node determination unit 133 are the node identifiers of one or more nodes that match the axon growth condition of the one or more node identifiers determined by the firing node determination unit 133. However, one or more node identifiers of the one or more node identifiers determined by the firing node determination unit 133 may be all of the node identifiers determined by the firing node determination unit 133.

Note that acquiring axon information in which an axon extending from a node is grown means changing the axon position information contained in the axon information to position information in which the end point of the axon indicated by the axon position information is located further away from the node.

The axon growth condition is a condition for performing axon growth processing. The axon growth condition is, for example, a condition based on count information. For example, the axon growth condition is “the number of firings is equal to or greater than a threshold value”, “the number of firings is greater than a threshold value”, “the firing frequency is equal to or greater than a threshold value”, or “the firing frequency is greater than a threshold value”. The axon generation condition may be the same as or different from the growth condition.

In addition, the processing performed to grow an axon extending from a node is processing performed to further acquire position information that specifies a position in the direction indicated by the goal information from the axon position information contained in the axon information that is paired with the node identifier that identifies the node, and to set the position information as the axon position information.

### (3) Node Generation Processing

The growth unit 134 performs, for example, node generation processing.

The node generation processing is processing performed to generate new node information. That is to say, the growth unit 134 performs node generation processing to generate and accumulate node information regarding a new node at a position in the direction indicated by the goal information that is paired with the one state determined by the state determination unit 131 and in the vicinity of the position indicated by node position information of one or more nodes identified by one or more node identifiers among the one or more node identifiers acquired by the firing node determination unit 133, for example.

For example, the growth unit 134 acquires a new node identifier. In addition, for example, the growth unit 134 acquires new node position information regarding a position that is in the direction indicated by the goal information that is paired with the one state determined by the state determination unit 131 and is a predetermined distance away from the position indicated by the node position information regarding the target node (firing node). In addition, for example, the growth unit 134 acquires information (for example, a firing condition or firing probability information) contained in the node information regarding the target node.

Thereafter, for example, the growth unit 134 forms node information that contains one or more pieces of information of a new node identifier, new node position information, a firing condition, and firing probability information, and accumulates the node information in the NN storage unit 113. Note that the predetermined distance may be a distance determined in advance or may change dynamically.

It is preferable that the one or more node identifiers of the one or more node identifiers are, for example, one or more node identifiers contained in the node information that matches the node generation condition of the one or more node identifiers. However, the one or more node identifiers of the one or more node identifiers may be, for example, all of the one or more node identifiers.

The node generation condition is a condition for generating a node. The node generation condition may be the same as or different from the growth condition. In addition, the node generation condition may be common to all nodes of interest, or may be different for each node. When the node generation condition is different for each node, the node information contains the node generation condition, for example.

### (4) Glial Cell Generation Processing

It is preferable that the growth unit 134 performs the glial cell generation processing described below. That is, for example, when the amount of energy retained in an element that is a node or edge becomes small enough to satisfy a predetermined condition with respect to the amount of required energy, the growth unit 134 generates glial cell information regarding the glial cell connected to the element. Note that the element may be an axon or a dendrite. That is to say, when the amount of energy retained in an element that is an axon or a dendrite becomes small enough to satisfy a predetermined condition with respect to the amount of required energy, the growth unit 134 generates glial cell information regarding the glial cell connected to the element.

The predetermined condition is, for example, “retained energy amount<required energy amount”, or “retained energy amount<=required energy amount”, or “retained energy amount-required energy amount<=threshold value”, or “retained energy amount-required energy amount<threshold value”.

More specifically, for example, the growth unit 134 judges whether or not the amount of retained energy indicated by the retained energy amount information contained in the information of each element (node information, edge information, axon information, or dendrite information) is small enough to satisfy a predetermined condition than the amount of required energy indicated by the required energy amount information contained in the information of each element, and if it is judged that the amount is smaller, the growth unit 134 generates glial cell information that contains an identifier that identifies the element (a node identifier, an edge identifier, an axon identifier, or a dendrite identifier) and accumulates it in the storage unit 11.

The output unit 14 outputs various kinds of information. Examples of the various kinds of information include the node identifier of a node that has fired, the NN information in the NN storage unit 113, and the state identifier acquired by the state determination unit 131.

Examples of the various kinds of information include a graphical representation of NN information. In such a case, the processing unit 13 forms a diagram of the nodes included in the NN (for example, spheres) from each piece of node information contained in the NN information, and forms a diagram of the edges included in the NN (for example, lines) from the edge information. In addition, the processing unit 13 places a diagram of the nodes (for example, spheres) at positions in virtual space indicated by the pieces of node position information contained in the pieces of node information, places a diagram of edges (for example, lines) whose end points are at positions in virtual space indicated by the pieces of edge position information of the pieces of edge information, and forms a diagram that explicitly shows that the nodes to which the edges are connected are connected to the diagram of the edges (e.g., lines).

Here, “output” is a concept that encompasses displaying on a display screen, projection using a projector, printing by a printer, the output of a sound, transmission to an external device, accumulation on a recording medium, delivery of a processing result to another processing device or another program, and the like.

It is preferable that the storage unit 11, the start point storage unit 111, the goal storage unit 112, and the NN storage unit 113 are realized using a non-volatile recording medium, but they can be realized using a volatile recording medium.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The acceptance unit 12 and the information acceptance unit 121 can be realized using a device such as a microphone or a camera. The acceptance unit 12 and so on may be realized using a wireless or wired communication means. The acceptance unit 12 and the information acceptance unit 121 may be realized using a processor, a memory, and so on.

The processing unit 13, the state determination unit 131, the feature acquisition unit 132, the firing node determination unit 133, and the growth unit 134 are typically realized using a processor, a memory, and so on. The processing procedures performed by the processing unit 13 and so on are typically realized using software, and the software is recorded on a recording medium such as a ROM. However, such processing procedures may be realized using hardware (a dedicated circuit). Note that the processor may be a CPU, an MPU, a GPU, or the like, and there is no limitation on the type thereof.

The output unit 14 may be regarded as including or not including an output device such as a display or a speaker. The output unit 14 can be realized using the driver software of the output device, the driver software of the output device and the output device, or the like.

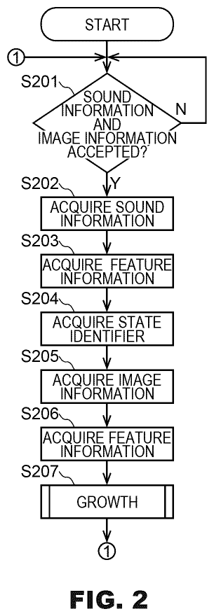

Next, examples of operations of the NN growth apparatus 1 will be described with reference to the flowchart in FIG. 2. First examples of operations of the NN growth apparatus 1 are examples in which the NN growth apparatus 1 does not include a node determination unit 130, which will be described later.

(Step S201) The information acceptance unit 121 judges whether or not sound information and image information have been accepted. If sound information and image information have been accepted, processing proceeds to step S202, and otherwise processing returns to step S201.

(Step S202) The state determination unit 131 acquires the sound information accepted in step S201.

(Step S203) The state determination unit 131 acquires one or more pieces of feature information from the sound information acquired in step S202.

(Step S204) The state determination unit 131 acquires state determination information from the storage unit 11. Using the state determination information and the one or more pieces of feature information acquired in step S203, the state determination unit 131 acquires the state identifier that identifies the state indicated by the sound information.

(Step S205) The feature acquisition unit 132 acquires the image information accepted in step S201.

(Step S206) The feature acquisition unit 132 acquires one or more pieces of feature information from the image information acquired in step S205.

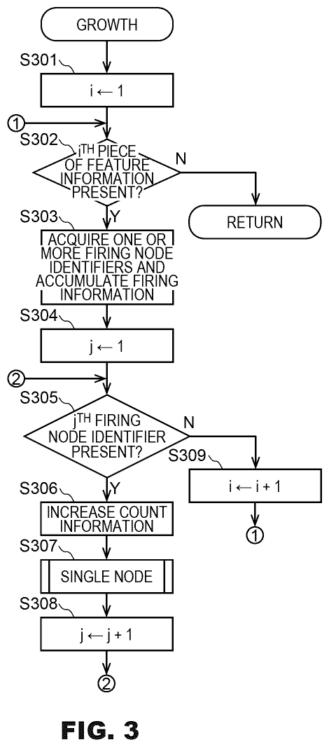

(Step S207) The growth unit 134 and so on perform growth processing. Processing returns to step S201. An example of growth processing will be described with reference to the flowchart in FIG. 3. Note that growth processing is processing performed to build neural network information stored in the NN storage unit 113.

Note that, in step S205 in the flowchart in FIG. 2, the feature acquisition unit 132 may acquire a partial image corresponding to the window determined by the determination unit 130, which will be described later, and in step S206, the feature acquisition unit 132 may acquire one or more pieces of feature information from the partial image. In such a case, it is preferable that the node determination unit 130 sequentially acquires partial images for different windows for the image information accepted in step S201, and the processing from step S205 to step S207 is repeated (looped) until the information acceptance unit 121 accepts the next image information and sound information in step S201.

In the flowchart shown in FIG. 2, processing is terminated when power is turned off or an interruption is made to terminate the processing.

Next, an example of the growth processing in step S207 will be described with reference to the flowchart in FIG. 3.

(Step S301) The firing node determination unit 133 substitutes 1 for a counter i.

(Step S302) The firing node determination unit 133 judges whether or not the i^{th} piece of feature information is present in the pieces of feature information acquired in step S206. If the i^{th} piece of feature information is present, processing proceeds to step S303, and otherwise processing returns to higher level processing.

(Step S303) The firing node determination unit 133 acquires, from the start point storage unit 111, the node identifiers contained in the one or more pieces of firing start point information that the i^{th} piece of feature information satisfies. The firing node determination unit 133 forms firing information that contains the node identifiers, and accumulates it in the storage unit 11. It is preferable that the firing node determination unit 133 acquires timer information indicating the points in time of firing from a clock (not shown), forms firing information containing the timer information and the node identifiers, and accumulates it in the storage unit 11. Such one or more node identifiers are the identifiers of the nodes that fire first. Such node identifiers are firing node identifiers.

(Step S304) The firing node determination unit 133 substitutes 1 for a counter j.

(Step S305) The firing node determination unit 133 judges whether or not the j^{th} firing node identifier is present in the firing node identifiers acquired in step S303. If the j^{th} firing node identifier is present, processing proceeds to step S306, and otherwise processing proceeds to step S309.

(Step S306) The firing node determination unit 133 performs an update to increase the count information contained in the node information corresponding to the j^{th} firing node identifier. For example, the firing node determination unit 133 reads out the count information contained in the node information corresponding to the j^{th} firing node identifier, and overwrites the count information with count information obtained by adding 1 to the count information.

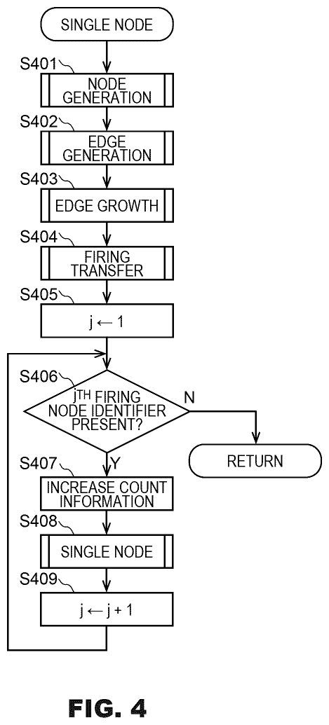

(Step S307) The growth unit 134 performs growth processing corresponding to the node (referred to as a “node of interest”) identified by the j^{th} firing node identifier (referred to as a “node-of-interest identifier”). Such a growth processing is referred to as single node processing. An example of single node processing will be described with reference to the flowchart in FIG. 4.

(Step S308) The firing node determination unit 133 increments the counter j by 1. Processing returns to step S305.

(Step S309) The firing node determination unit 133 increments the counter i by 1. Processing returns to step S302.

Next, an example of the single node processing in step S307 will be described with reference to the flowchart in FIG. 4.

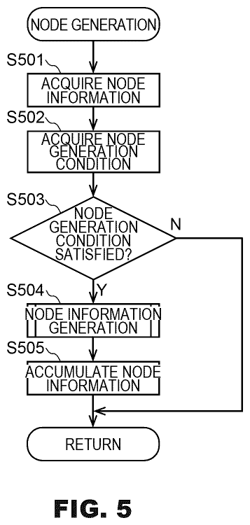

(Step S401) The growth unit 134 performs processing to generate a new node with respect to the node of interest identified by the node-of-interest identifier. An example of such node generation processing will be described with reference to the flowchart in FIG. 5.

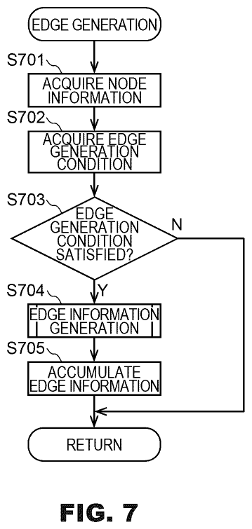

(Step S402) The growth unit 134 performs processing to generate edges to be connected to the node of interest. An example of such edge generation processing will be described with reference to the flowchart in FIG. 7.

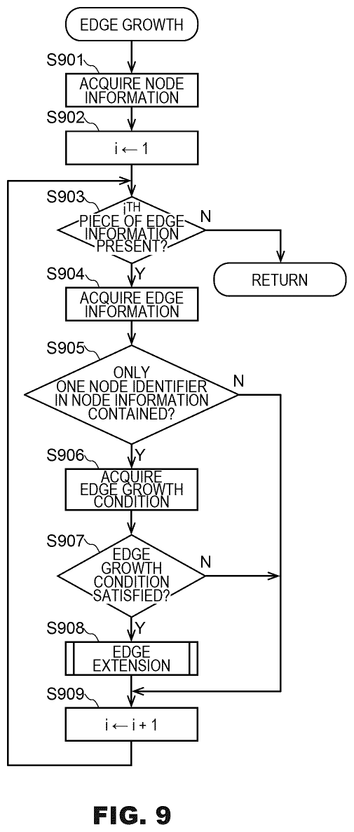

(Step S403) The growth unit 134 performs processing to growth the edges connected to the node of interest. An example of such edge growth processing will be described with reference to the flowchart in FIG. 9.

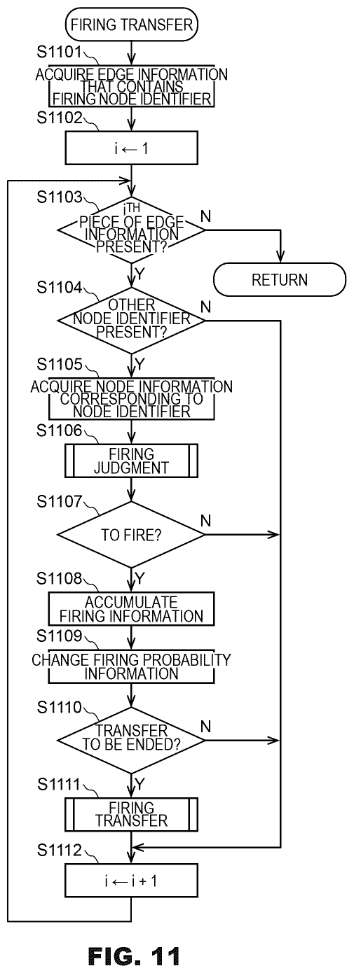

(Step S404) The firing node determination unit 133 performs firing transfer processing. An example of firing transfer processing will be described with reference to the flowchart in FIG. 11. Note that firing transfer processing is processing performed to transfer feature information from the node of interest and determine firing nodes.

(Step S405) The firing node determination unit 133 substitutes 1 for the counter j.

(Step S406) The firing node determination unit 133 judges whether or not the j^{th} firing node identifier is present in the firing node identifiers of the nodes judged as firing nodes in step S404. If the j^{th} firing node identifier is present, processing proceeds to step S407, and otherwise processing returns to higher level processing.

(Step S407) The firing node determination unit 133 increases the count information paired with the j^{th} firing node identifier.

(Step S408) The growth unit 134 and so on perform single node processing, where the firing node identified by the j^{th} firing node identifier is the node of interest. An example of single node processing will be described with reference to the flowchart in FIG. 4.

(Step S409) The firing node determination unit 133 increments the counter j by 1. Processing returns to step S406.

Next, an example of the node generation processing in step S401 will be described with reference to the flowchart in FIG. 5.

(Step S501) The growth unit 134 acquires the piece of node information corresponding to the node-of-interest identifier from the NN storage unit 113.

(Step S502) The growth unit 134 acquires a node generation condition.

(Step S503) The growth unit 134 judges whether or not the node information acquired in step S501 satisfies the node generation condition acquired in step S502. If the node generation condition is satisfied, processing proceeds to step S504, and if the node generation condition is not satisfied, processing returns to higher level processing.

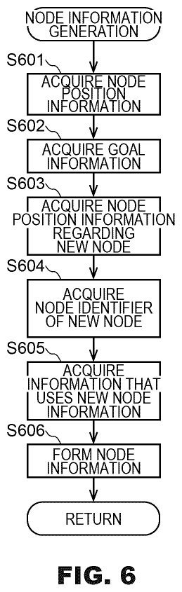

(Step S504) The growth unit 134 performs node information generation processing. An example of node information generation processing will be described with reference to the flowchart in FIG. 6.

(Step S505) The growth unit 134 accumulates the node information formed in step S504 in the NN storage unit 113. Processing returns to higher level processing.

Next, an example of the node information generation processing in step S504 will be described with reference to the flowchart in FIG. 6.

(Step S601) The growth unit 134 acquires node position information contained in the node of interest information identified by the node-of-interest identifier.

(Step S602) The growth unit 134 acquires goal information corresponding to the state identifier acquired in step S203 from the goal storage unit 112.

(Step S603) Using the node position information acquired in step S601 and the goal information acquired in step S602, the growth unit 134 acquires node position information indicating a position in the direction specified by the goal information with respect to the position specified by the node position information acquired in step S601. Such node position information is position information regarding a new node.

The growth unit 134 acquires, for example, node position information indicating a position that is a predetermined distance away from the position indicated by the node position information acquired in step S601 in the direction specified by the goal information. For example, if there is another node in the direction specified by the goal information with respect to the position indicated by the node position information acquired in step S601, the growth unit 134 acquires node position information indicating a position that is between the node position information of the other node in the direction specified by the goal information and the position indicated by the node position information acquired in step S601, and that is away therefrom by a distance within a predetermined distance range. That is to say, when the growth unit 134 acquires node position information of a new node, the growth unit 134 need only acquire node position information in the direction specified by the goal information, and there is no limitation on the node position information.

(Step S604) The growth unit 134 acquires the node identifier of the new node. The growth unit 134 generates a new node identifier. However, the growth unit 134 may acquire an unused node identifier from the set of node identifiers.

(Step S605) The growth unit 134 acquires information regarding the node to be used in the node information of the new node and contained in the node information acquired in step S501. Examples of such information include a firing condition, firing probability information, and retained energy amount information.

(Step S606) The growth unit 134 forms node information that contains the node identifier acquired in step S604, the node position information acquired in step S603, and the information acquired in step S605. Processing returns to higher level processing.

Next, an example of the edge generation processing in step S402 will be described with reference to the flowchart in FIG. 7.

(Step S701) The growth unit 134 acquires the piece of node information identified by the node-of-interest identifier from the NN storage unit 113.

(Step S702) The growth unit 134 acquires an edge generation condition.

(Step S703) The growth unit 134 judges whether or not the node information acquired in step S701 satisfies the edge generation condition acquired in step S701. If the edge generation condition is satisfied, processing proceeds to step S704, and otherwise processing returns to higher level processing.

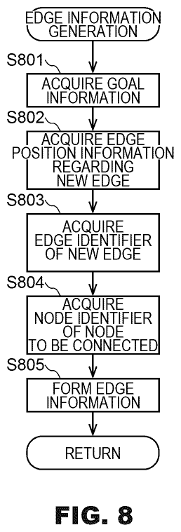

(Step S704) The growth unit 134 performs edge information generation processing. An example of edge information generation processing will be described with reference to the flowchart in FIG. 8.

(Step S705) The growth unit 134 accumulates the edge information formed in step S704 in the NN storage unit 113. Processing returns to higher level processing.

Next, an example of the edge information generation processing in step S704 will be described with reference to the flowchart in FIG. 8.

(Step S801) The growth unit 134 acquires goal information corresponding to the state identifier acquired in step S203 from the goal storage unit 112.

(Step S802) Using the node position information acquired in step S601 and the goal information acquired in step S801, the growth unit 134 acquires edge position information regarding the new edge. The growth unit 134 acquires edge position information regarding an edge extending from the position indicated by the node position information in the direction indicated by the goal information. Note that, for example, the distance between the position indicated by the edge position information and the position indicated by the node position information may or may not be determined in advance.

The growth unit 134 acquires, for example, edge position information indicating a position that is a predetermined distance away from the position indicated by the node position information acquired in step S601 in the direction specified by the goal information. For example, when another node is present in the direction specified by the goal information from the position indicated by the node position information acquired in step S601, the growth unit 134 acquires the node position information of the other node as edge position information. That is to say, here, the generated edge is an edge that connects the node corresponding to the node position information acquired in step S601 with the other node. For example, when another node is present in the direction specified by the goal information from the position indicated by the node position information acquired in step S601, and the distance between the position indicated by the node position information acquired in step S601 and the position indicated by the node position information of the other node is not less than a threshold value or greater than a threshold value, the growth unit 134 acquires node position information indicating a position a predetermined distance away from the position indicated by the node position information acquired in step S601, and when the distance between the position indicated by the node position information acquired in step S601 and the position indicated by the node position information of the other node is less than a threshold value or not greater than a threshold value, the growth unit 134 acquires the node position information of the other node as edge position information. That is to say, the growth unit 134 need only acquire edge position information of an edge extending from the position indicated by the node position information in the direction indicated by the goal information, and there is no limitation on the edge position information.

(Step S803) The growth unit 134 acquires the edge identifier of the new edge. For example, the growth unit 134 generates a new edge identifier. For example, the growth unit 134 acquires an unused edge identifier from a raw set of edge identifiers.

(Step S804) The growth unit 134 acquires the node identifier (the node-of-interest identifier) of the node to which the edge is connected. Here, the growth unit 134 acquires a node identifier that is paired with the node position information acquired in step S601. The growth unit 134 may acquire the node identifier of the newly connected node.

(Step S805) The growth unit 134 forms edge information that contains the edge identifier acquired in step S803, the edge position information acquired in step S802, and the one or two node identifiers acquired in step S804. Processing returns to higher level processing.

In the flowchart in FIG. 8, the edge corresponding to the generated edge information may be in a state where there is no node connected ahead, or may be in a state where there is a node connected ahead.

If there is a node connected ahead to the edge corresponding to the generated edge information, the growth unit 134 acquires the node identifier that is paired with the node position information regarding the position in the direction indicated by the goal information as the node identifier of the connected node. Note that when the growth unit 134 always forms and accumulates edge information such that a generated edge connects two nodes, edge growth processing is not performed normally.

Next, an example of the edge growth processing in step S403 will be described with reference to the flowchart in FIG. 9.

(Step S901) The growth unit 134 acquires the piece of node information identified by the node-of-interest identifier from the NN storage unit 113.

(Step S902) The growth unit 134 substitutes 1 for the counter i.

(Step S903) The growth unit 134 judges whether or not the i^{th} piece of edge information is present in the NN storage unit 113. If the i^{th} piece of edge information is present, processing proceeds to step S904, and otherwise processing returns to higher level processing.

(Step S904) The growth unit 134 acquires the i^{th} piece of edge information from the NN storage unit 113.

(Step S905) The growth unit 134 judges whether or not a node is connected to the end of the edge corresponding to the i^{th} piece of edge information. More specifically, the growth unit 134 judges whether or not the node identifier contained in the i^{th} piece of edge information is the only node-of-interest identifier. If there is only the node-of-interest identifier, processing proceeds to step S906, and if there is not only the node-of-interest identifier (if there are two node identifiers), processing proceeds to step S909. Note that edge information containing only the node-of-interest identifier is edge information regarding an edge that is connected to the node of interest and can grow.

(Step S906) The growth unit 134 acquires an edge growth condition.

(Step S907) The growth unit 134 judges whether or not the edge information acquired in step S904 satisfies the edge growth condition. If the edge growth condition is satisfied, processing proceeds to step S908, and otherwise processing proceeds to step S909.

Here, the growth unit 134 may judge whether or not the node information of the node identified by the node identifier contained in the edge information acquired in step S904 satisfies the edge growth condition.

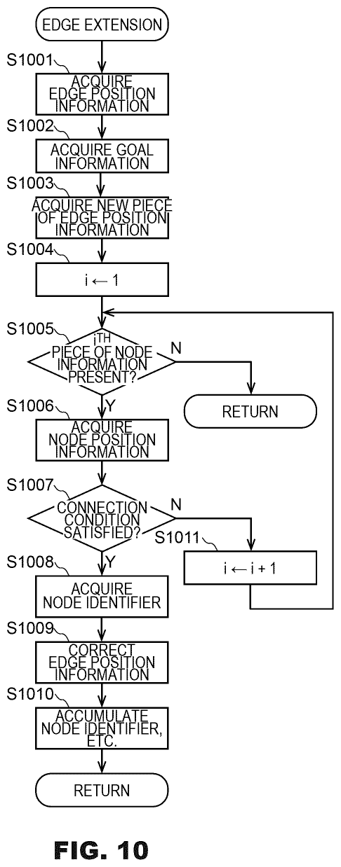

(Step S908) The growth unit 134 performs edge extension processing. An example of edge extension processing will be described with reference to the flowchart in FIG. 10.

Note that edge extension processing is processing performed to extend the length of an edge, and is typically processing performed to change edge position information or processing performed to add the node identifier of the connection destination node to edge information.

(Step S909) The growth unit 134 increments the counter i by 1. Processing returns to step S903.

Note that, in the flowchart in FIG. 9, edge growth processing may be replaced with dendrite growth processing for the dendrites included in edges, or axon growth processing for axons.

Next, an example of the edge extension processing in step S908 will be described with reference to the flowchart in FIG. 10.

(Step S1001) The growth unit 134 acquires edge position information contained in the acquired edge information.

(Step S1002) The growth unit 134 acquires goal information.

(Step S1003) Using the edge position information acquired in step S1001 and the goal information acquired in step S1002, the growth unit 134 acquires new edge position information and updates the edge position information. Note that the growth unit 134 acquires, from the edge position information, position information that specifies a position in the direction indicated by the goal information.

The growth unit 134 acquires, for example, edge position information indicating a position that is a predetermined distance away from the position indicated by the edge position information acquired in step S1001 in the direction specified by the goal information. For example, if there is another node in the direction specified by the goal information with respect to the position indicated by the edge position information acquired in step S1001, the growth unit 134 acquires edge position information indicating a position that is between the position indicated by the edge position information and the position indicated by the node position information of the other node in the direction specified by the goal information, and that is away therefrom by a distance within a predetermined distance range. For example, when another node is present in the direction specified by the goal information from the position indicated by the edge position information acquired in step S1001, the growth unit 134 acquires the node position information of the other node as edge position information. That is to say, when the growth unit 134 acquires new edge position information, the growth unit 134 need only acquire edge position information in the direction specified by the goal information from the current edge position information, and there is no limitation on the edge position information. Note that when node position information of another node is acquired as edge position information, the edge is connected to the other node by edge extension processing, as described later. In such a case, the growth unit 134 may acquire the node identifier of the other node.

(Step S1004) The growth unit 134 substitutes 1 for the counter i.

(Step S1005) The growth unit 134 judges whether or not the i^{th} piece of node information is present in the NN storage unit 113. If the i^{th} piece of node information is present, processing proceeds to step S1006, and otherwise processing returns to higher level processing.

(Step S1006) The growth unit 134 acquires the node position information contained in the i^{th} piece of node information.

(Step S1007) The growth unit 134 judges whether or not the node position information acquired in step S1006 satisfies a connection condition. If the connection condition is satisfied, processing proceeds to step S1008, and otherwise processing proceeds to step S1011. Note that the connection condition is a condition for an edge to be connected to a node. The connection condition is, for example, that the distance between the position indicated by the node position information acquired in step S1006 and the position indicated by the new piece of edge position information acquired in step S1003 is not treater than a threshold value or less than a threshold value.

(Step S1008) The growth unit 134 acquires the node identifier contained in the i^{th} piece of node information.

(Step S1009) The growth unit 134 changes the edge position information updated in step S1003 to the node position information contained in the i^{th} piece of node information.

(Step S1010) The growth unit 134 adds the node identifier acquired in step S1008 to the acquired edge information. Processing returns to higher level processing.

(Step S1011) The growth unit 134 increments the counter i by 1. Processing returns to step S1005.

Note that, in the flowchart in FIG. 10, edge extension processing may be replaced with dendrite growth processing for the dendrites included in edges, or axon growth processing for axons.

Dendrite extension processing is processing performed to extend a dendrite, and is processing in which edge information is replaced with dendrite information in the processing described with reference to FIG. 10. Axon extension processing is processing performed to extend an axon, and is processing in which edge information is replaced with axon information in the processing described with reference to FIG. 10.

In the flowchart in FIG. 10, processing may proceed to step S1011 after the processing in step S1010. In such a case, an edge may branch and connect to two or more nodes.

In addition, in step S1007 in the flowchart in FIG. 10, the distance between the new piece of edge position information acquired in step S1003 and the node position information of each node may be calculated, and it may be judged whether or not the node position information of the node with the smallest distance satisfies the connection condition.

Next, an example of the firing transfer processing in step S404 will be described with reference to the flowchart in FIG. 11.

(Step S1101) The firing node determination unit 133 acquires all the pieces of edge information that contain a firing node identifier from the NN storage unit 113.

(Step S1102) The firing node determination unit 133 substitutes 1 for the counter i.

(Step S1103) The firing node determination unit 133 judges whether or not the i^{th} piece of edge information is present in the pieces of edge information acquired in step S1101. If the i^{th} piece of edge information is present, processing proceeds to step S1104, and otherwise processing returns to higher level processing.

(Step S1104) The firing node determination unit 133 judges whether or not the node identifier of another node is present in the i^{th} piece of edge information. If the node identifier of another node is present, processing proceeds to step S1105, and otherwise processing proceeds to step S1112. Note that the node identifier of another node in the edge information is the node identifier of the connection destination node of the edge.

(Step S1105) The firing node determination unit 133 acquires the node identifier of the other node in the i^{th} piece of edge information. Next, the firing node determination unit 133 acquires, from the NN storage unit 113, the node information regarding the node identified by the node identifier.

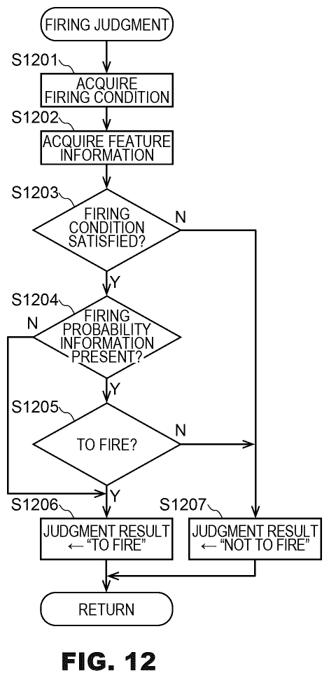

(Step S1106) Using the node information acquired in step S1105, the firing node determination unit 133 judges whether or not the node corresponding to the node information fires. An example of such firing judgment processing will be described with reference to the flowchart in FIG. 12.

(Step S1107) If the judgment result in step S1106 is “fire”, the firing node determination unit 133 proceeds to step S1108, and if the judgment result is “not fire”, the firing node determination unit 133 proceeds to step S1112.

(Step S1108) The firing node determination unit 133 acquires firing information that contains the node identifier contained in the node information acquired in step S1105, and accumulates the firing information in the storage unit 11.

(Step S1109) The firing node determination unit 133 changes the firing probability information contained in the node information acquired in step S1105. Here, the firing node determination unit 133 changes the firing probability information so that the firing probability specified by the firing probability information increases.

(Step S1110) The firing node determination unit 133 judges whether or not to end the transfer of firing (which may also be referred to as the transfer of information) between nodes. If the transfer is to be ended, processing proceeds to step S1112, and if the transfer is not to be ended, processing proceeds to step S1111. Note that when the transfer is to be ended is, for example, when the node is a terminal node in the NN.

(Step S1111) The firing node determination unit 133 performs firing transfer processing where the node is the node of interest. An example of firing transfer processing is shown in FIG. 11.

(Step S1112) The firing node determination unit 133 increments the counter i by 1. Processing returns to step S1103.

In the flowchart in FIG. 11, it is preferable that, when transferring firing (transferring information) between nodes, the firing node determination unit 133 updates the retained energy amount information to one that has been obtained by reducing the amount of energy indicated by the retained energy amount information contained in the firing origin node information. The same may also be applied to the retained energy amount information that is paired with the axon identifier of the axon used for the transfer, and the retained energy amount information that is paired with the dendrite identifier of the dendrite used for the transfer. In addition, it is assumed that the function for reducing the amount of energy is stored in the storage unit 11, for example. There is no limitation on the function. The function is a well-known technique, and therefore a detailed description will be omitted.

In the flowchart of FIG. 11, the firing node determination unit 133 typically performs processing to transfer one or more pieces of feature information accepted by the firing origin node to the firing destination node.

Next, an example of the firing judgment processing in step S1106 will be described with reference to the flowchart in FIG. 12.

(Step S1201) The firing node determination unit 133 acquires a firing condition corresponding to the node information acquired in step S1105.

(Step S1202) The firing node determination unit 133 acquires one or more pieces of feature information. Note that the one or more pieces of feature information are pieces of feature information transferred from the firing origin node.

(Step S1203) The firing node determination unit 133 judges whether or not the one or more pieces of feature information acquired in step S1202 satisfy the firing condition acquired in step S1201. If the firing condition is satisfied, processing proceeds to step S1204, and if the firing condition is not satisfied, processing proceeds to step S1207.

(Step S1204) The firing node determination unit 133 judges whether or not the node information of interest contains firing probability information. If the firing probability information is contained, processing proceeds to step S1205, and if firing probability information is not contained, processing proceeds to step S1206.

(Step S1205) The firing node determination unit 133 acquires the firing probability information contained in the node information of interest. Next, using the firing probability information, the firing node determination unit 133 judges whether or not the node is to fire. If the node is to fire, processing proceeds to step S1206, and if the node is not to fire, processing proceeds to step S1207.

(Step S1206) The firing node determination unit 133 substitutes “fire” for the judgment result. Processing returns to higher level processing.

(Step S1207) The firing node determination unit 133 substitutes “not fire” for the judgment result. Processing returns to higher level processing.

As described above, with the present embodiment, it is possible to simulate fetal brain growth. That is to say, with the present embodiment, it is possible to realize infant brain growth model. Note that infant brain growth is the growth of the nodes, or edges, or nodes and edges that are included in the neural network based on image information and sound information.

Note that the processing in the present embodiment may be realized using software. This software may be distributed through software downloading or the like. Also, this software may be recorded on a recording medium such as a CD-ROM and distributed. Note that the same applies to the other embodiments in the present description. Note that the software that realizes the NN growth apparatus 1 according to the present embodiment is the program described below. That is to say, this program is a program that enables a computer that can access: an NN storage unit in which neural network information is stored, the neural network information containing two or more pieces of node information each containing a node identifier, and one or more pieces of edge information each containing an edge identifier and specifying a connection between nodes; a start point storage unit in which one or more pieces of firing start point information are stored, each piece of firing start point information containing an information identifier that identifies feature information of image information and one or more node identifiers that identify nodes that initially fire when the feature information is accepted; and a goal storage unit in which pieces of goal information is stored, the pieces of goal information specifying goals respectively corresponding to two or more states that include positive and negative states, to function as: an information acceptance unit that accepts image information and sound information; a state determination unit that determines one state from among the two or more states, using the sound information accepted by the information acceptance unit; a feature acquisition unit that acquires, using the image information accepted by the information acceptance unit, one or more pieces of feature information corresponding to the image information; a firing node determination unit that determines one or more node identifiers of one or more firing nodes corresponding to the one or more pieces of feature information acquired by the feature acquisition unit, from the start point storage unit, and determines a node identifier of a firing node that is connected to the one or more nodes identified by the one or more node identifiers by edges and to which the feature information is to be transferred; and a growth unit that acquires the goal information paired with the one state determined by the state determination unit, and, using the goal information, performs processing to grow node information or edge information corresponding to one or more node identifiers of the one or more node identifiers determined by the firing node determination unit.

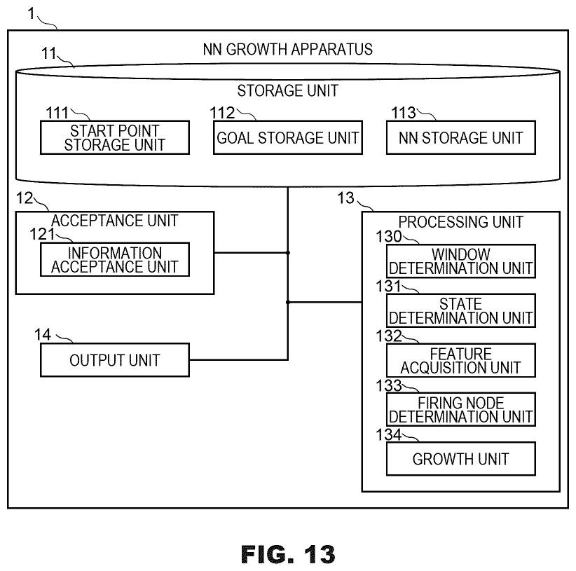

In the present embodiment, the NN growth apparatus 1 may have a structure shown in the block diagram in FIG. 13. That is to say, the processing unit 13 of the NN growth apparatus 1 may include a window determination unit 130.

The window determination unit 130 determines, from a still image or a still image constituting a moving image accepted by the information acceptance unit 121, a sliding window (hereinafter, referred to as a “window” where appropriate) that is a partial region of the still image. The window is the region that the infant focuses on and looks at, and therefore may be referred to as a region of interest. Although it is preferable that the window size is constant, it may vary. The shape of the window is, for example, a rectangle, but it may be another shape such as an ellipse or a circle.

For example, while changing the reference point of a window, which is a reference point in a still image or a still image constituting a moving image accepted by the information acceptance unit 121, the window determination unit 130 sequentially determines windows corresponding to the reference point. Note that the reference point of a window is, for example, the center of gravity of the window or a specific end point (for example, the upper left coordinate value).

The window determination unit 130 transfers, for example, a partial image, which is an image within the determined window, to the feature acquisition unit 132. The partial image is an image of a partial region of a still image or a still image constituting a moving image accepted by the information acceptance unit 121.

For example, the window determination unit 130 generates a random number corresponding to the value of X, obtains the value of X using the random number, and generates a random number corresponding to the value of Y, and obtains the value of Y using the random number. For example, the window determination unit 130 uses the previous old reference point (X₁, Y₁), a random number (X_{R}) corresponding to the value of X, and a random number (Y_{R}) corresponding to the value of Y to obtain the next reference point (X₁+X_{R}, Y₁+Y_{R}) or (X₁−X_{R}, Y₁−Y_{R}). In such a case, the obtained random number is the amount of change in the reference point. Note that the window determination unit 130 may, for example, regularly obtain a new reference point with respect to the previous old reference point.

For example, the reference point is any one of an initial reference point, a first reference point, and a second reference point. The initial reference point is a reference point when a window is initially determined from image information. For example, the initial reference point is the center point of the image information, but there is no limitation. For example, the initial reference point may be determined by obtaining the X coordinate value and the Y coordinate value using random numbers. The first reference point is a point slightly moved from the previously determined reference point (old reference point), and is the reference point of the next window. The amount of change at the slightly moved point is, for example, the value of a generated random number, but it may be fixed, and there is no limitation. The second reference point is a reference point when the firing node satisfies an interest condition, and is a point slightly moved from the old reference point. Note that the amount of change at the first reference point is greater than the amount of change at the second reference point.

For example, the window determination unit 130 acquires a partial image having a size of a window, centered around the reference point from a still image or a still image constituting a moving image accepted by the information acceptance unit 121. For example, the window determination unit 130 acquires region information (for example, the top left coordinate value, the bottom right coordinate value, the center point coordinate value, and the radius) that specifies the region of a partial image having a size of a window with a reference point as the center.

The processing performed by the window determination unit 130 to determine a window using such random numbers corresponds to a saccade, which is a movement of the eyeball.

For example, the window determination unit 130 judges whether or not the node identifier of each of the one or more fired nodes matches any interest condition of one or more interest conditions, and if any interest condition is met, determines the image (here, typically a partial image) that caused the one or more nodes to fire as the window of interest. After determining the window of interest, the window determination unit 130 generates a random number, for example, in a small range of values, determines a window corresponding to the second reference point shifted by the amount of the random number relative to the old reference point of the window of interest, and repeats the processing performed to set the window as the window of interest.

The interest condition is information used to determine whether or not an image is attractive to an infant or is an image that the infant wants to see. Each interest condition contains one or more node identifiers. For example, the interest condition contain two or more node identifiers (a set of identifiers of a group of nodes) and a condition related to a threshold value for the fired nodes (for example, “a percentage of nodes that have fired in a specific group of nodes that is not less than or greater than the threshold”, or “a number of nodes that have fired in a specific group of nodes that is not less than or greater than the threshold”).

Note that the node identifiers of the fired nodes are the node identifiers acquired by the firing node determination unit 133.

It is preferable that the window determination unit 130 determines a new window until, for example, a transition condition is satisfied. The transition condition is a condition for using the next piece of image information or the like. The transition condition is, for example, “window has been determined a threshold number of times from one piece of image information”, “a threshold time or more has elapsed since the acceptance of one image information”, or “the next piece of image information or the like has been accepted”. However, there is no limitation on the transition condition.

For example, the feature acquisition unit 132 in FIG. 13 uses partial images corresponding to the sliding windows sequentially determined by the window determination unit 130 to acquire one or more pieces of feature information for the partial images.

For example, the feature acquisition unit 132 uses a first partial image in a window determined by the window determination unit 130, which is a region in one piece of image information, and a second partial image in a window determined by the window determination unit 130, which is a region in a piece of image information that precedes the one piece of image information in a time sequence, to acquire the amount of movement between the two partial images. Such an amount of movement is an example of feature information of the moving images acquired by the feature acquisition unit 132.

The feature acquisition unit 132 may acquire, for example, a first movement amount, which is the amount of movement between a first partial image and second partial image immediately preceding the first partial image, a second movement amount, which is the amount of movement between the first image information and a second partial image that is two images before the first partial image, and an N^{th} movement amount, which is the amount of movement between the first partial image and an N^{th} partial image that is N images before the first partial image, and form a movement amount vector (first movement amount, second movement amount, . . . , N^{th} movement amount). Such a movement amount vector is also an example of feature information of the moving images acquired by the feature acquisition unit 132.

The movement amount between images is information that specifies the amount of movement between two images. The movement amount is, for example, a motion vector or an optical flow.

The window determination unit 130 are typically realized using a processor, a memory, and so on. The processing procedures performed by the window determination unit 130 are typically realized using software, and the software is recorded on a recording medium such as a ROM. However, such processing procedures may be realized using hardware (a dedicated circuit). Note that the processor may be a CPU, an MPU, a GPU, or the like, and there is no limitation on the type thereof.

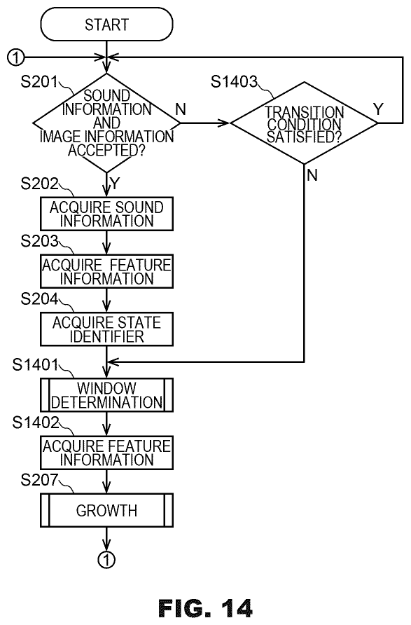

For example, the NN growth apparatus 1 in FIG. 13 may perform the operations in the flowchart shown in FIG. 14. The examples of operations of the NN growth apparatus 1 shown in FIG. 14 are those in the case where the node determination unit 130 functions. In the flowchart in FIG. 14, descriptions of the same steps as those in the flowchart in FIG. 2 will be omitted.

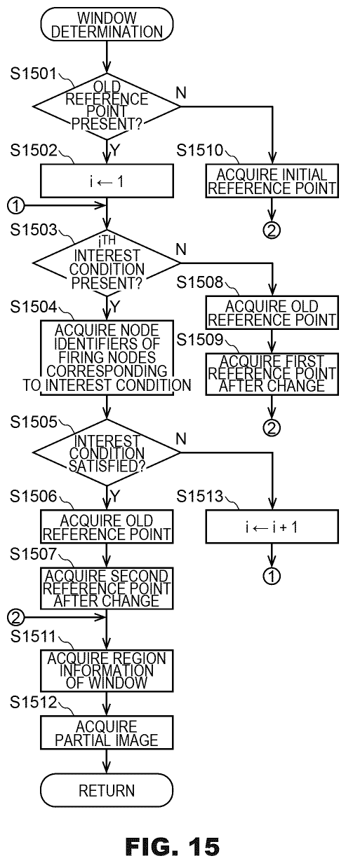

(Step S1401) The window determination unit 130 performs window determination processing. An example of window determination processing will be described with reference to the flowchart in FIG. 15.

(Step S1402) The feature acquisition unit 132 acquires one or more pieces of feature information, using the partial image acquired in step S1401.

(Step S1403) The window determination unit 130 judges whether or not a transition condition, which is a condition for using the next piece of image information or the like, is satisfied. If the transition condition is satisfied, processing returns to step S201, and if the transition condition is not satisfied, processing proceeds to step S1401.

Next, an example of the window determination processing in step S1401 will be described with reference to the flowchart in FIG. 15.

(Step S1501) The window determination unit 130 determines whether or an old reference point, which is a reference point for the one piece of image information accepted in S201 and is a reference point for a previously determined window, is present. If the old reference point is present, processing proceeds to step S1502, and if the old reference point is not present, processing proceeds to step S1510.

(Step S1502) The window determination unit 130 substitutes 1 for the counter i.

(Step S1503) The window determination unit 130 judges whether or not the i^{th} interest condition is present in the storage unit 11. If the i^{th} interest condition is present, processing proceeds to step S1504, and otherwise processing proceeds to step S1508.

(Step S1504) The window determination unit 130 acquires the node identifiers of one or more firing nodes corresponding to the i^{th} interest condition.

(Step S1505) The window determination unit 130 judges whether or not the one or more node identifiers acquired in step S1504 satisfy the i^{th} interest condition. If the i^{th} interest condition is satisfied, processing proceeds to step S1506, and otherwise processing proceeds to step S1513.

(Step S1506) The window determination unit 130 acquires the old reference point.

(Step S1507) The window determination unit 130 acquires the second reference point that is based on the old reference point. Processing proceeds to step S1511. Note that the second reference point is a point slightly moved from the old reference point.

(Step S1508) The window determination unit 130 acquires the old reference point.

(Step S1509) The window determination unit 130 acquires the first reference point that is based on the old reference point. Processing proceeds to step S1511. Note that the first reference point is a point slightly moved from the old reference point. It is also preferable that the distances of movement from the old reference point when determining the first and second reference points are different.

(Step S1510) The window determination unit 130 acquires the initial reference point corresponding to one piece of image information. Processing proceeds to step S1511.

(Step S1511) The window determination unit 130 acquires region information that specifies the window region, using the acquired reference point. Note that the acquired reference point is the initial reference point, the first reference point, or the second reference point.

(Step S1512) The window determination unit 130 acquires a partial image, which is an image of the region specified by the region information acquired in step S1511, from the image information accepted in step S201. Processing returns to higher level processing.

(Step S1513) The window determination unit 130 increments the counter i by 1. Processing returns to step S1503.

### Second Embodiment

The present embodiment describes an information processing apparatus that uses neural network information generated by the NN generation apparatus 1 to acquire a firing pattern corresponding to the accepted image information and/or sound information and output information corresponding to the firing pattern.

The present embodiment also describes an information processing apparatus in which the speed of information transfer between nodes changes depending on temperature information.

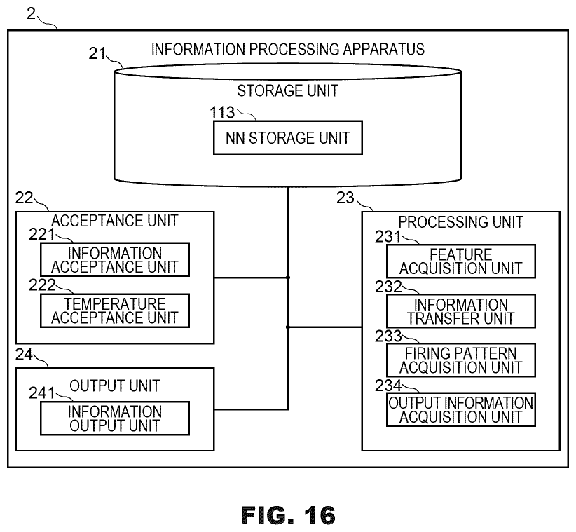

FIG. 16 is a block diagram of an information processing apparatus 2 according to the present embodiment. The information processing apparatus 2 includes a storage unit 21, an acceptance unit 22, a processing unit 23, and an output unit 24. The storage unit 21 includes the NN storage unit 113. The acceptance unit 22 includes an information acceptance unit 221 and a temperature acceptance unit 222. The processing unit 23 includes a feature acquisition unit 231, an information transfer unit 232, a firing pattern acquisition unit 233, and an output information acquisition unit 234. The output unit 24 includes an information output unit 241.

The storage unit 21 included in the information processing apparatus 2 stores various kinds of information. Examples of the various kinds of information include neural network information, one or more pieces of firing start point information, and one or more pieces of output management information.

The firing start point information is information containing an information identifier that identifies feature information of acceptance information, and one or more node identifiers that identify nodes that fire first when the feature information is accepted.

The acceptance information is information accepted by the information acceptance unit 221. The acceptance information contains image information or sound information. The acceptance information may be two or more kinds of information. The acceptance information may contain, for example, tactile information and smell information. The tactile information is information related to the sense of touch. The tactile information is information related to the sense of touch.

The output management information is information that contains an output condition and output information. The output management information may be information consisting of a pair of an output condition and output information.

The output condition is a condition used to determine output information. The output condition is a condition for outputting using the firing pattern. The output condition may be the firing pattern itself, or information that contains the firing pattern and output probability information. The output probability information is information regarding the probability for acquiring the output information. The output condition may be a firing pattern and information regarding a lower limit of the number of node identifiers that the applied firing pattern has, a firing pattern and information regarding a lower limit of the ratio of node identifiers that the applied firing pattern has, or the like. The firing pattern contains one or more node identifiers. The firing pattern is a pattern of firing of one or more nodes. The output information is information corresponding to the firing pattern.

The output information is, for example, emotion information regarding the emotion of a person (particularly, an infant), behavior information regarding the body movement of a person (particularly, an infant), and the like. The emotion information indicates, for example, happiness, sadness, fear, surprise, or the like. The emotion information is, for example, an ID that identifies an emotion. The emotion information may be the state identifier described above. The behavior information is, for example, information reflected in the movement of an avatar (character). The behavior information is, for example, information reflected in the movement of an avatar of an infant. The technology for moving an avatar is a well-known technology, and therefore a detailed description thereof will be omitted.

The output condition may be a condition using the firing pattern and one or more pieces of information related to external information. External information is information that is external. The external information may be referred to as user context. The external information is, for example, temperature, weather, smell, sound, light, or the like.

The NN storage unit 113 stores the neural network information accumulated by the NN growth apparatus 1.

The acceptance unit 22 accepts various kinds of information. Example of the various kinds of information include acceptance information and temperature information.

The information acceptance unit 221 accepts acceptance information. The information acceptance unit 221 acquires, for example, image information acquired by a camera. The information acceptance unit 221 may accept sound information acquired by a microphone.

The “acceptance” here is a concept that includes, for example, acceptance of information acquired by a device such as a camera or a microphone, reception of information transmitted via a wired or wireless communication network, or acceptance of information read out from a recording medium such as an optical disk, a magnetic disk, or a semiconductor memory.

The temperature acceptance unit 222 accepts temperature information. Temperature information is information that specifies a temperature. The temperature is, for example, the temperature of the external environment.

The “acceptance” here is a concept that includes, for example, acceptance of information input from an input device such as a microphone, a keyboard, a mouse, or a touch panel, reception of information transmitted via a wired or wireless communication network, or acceptance of information read out from a recording medium such as an optical disk, a magnetic disk, or a semiconductor memory.

The processing unit 23 performs various kinds of processing. The various kinds of processing are, for example, the processing performed by the feature acquisition unit 231, the information transfer unit 232, the firing pattern acquisition unit 233, and the output information acquisition unit 234.

The feature acquisition unit 231 uses the image information accepted by the information acceptance unit 221 to acquire one or more pieces of feature information corresponding to the image information. The processing performed by the feature acquisition unit 231 may be the same as the processing performed by the feature acquisition unit 132.

The information transfer unit 232 determines node identifiers corresponding to the one or more pieces of feature information acquired by the feature acquisition unit 231 from one or more pieces of firing start point information. Such node identifiers are firing node identifiers. Such node identifiers are the identifiers of the nodes that fire in the first stage.

Next, the information transfer unit 232 determines the node identifier of a node that is connected by an edge to one or more nodes identified by the one or more determined node identifiers, to which feature information is transferred, and is to fire.

The information transfer unit 232 performs information transfer processing, which is processing performed to transfer feature information from one firing node to the next firing node that is to fire. The next firing node is the node that is connected to the one firing node by an edge and is judged to be a node that is to fire.

The information transfer unit 232 acquires node information regarding nodes connected to one firing node by edges. Next, the information transfer unit 232 judges whether or not the node information satisfies the firing condition. Thereafter, the information transfer unit 232 forms and accumulates firing information that contains the node identifier contained in the node information that satisfies the firing condition.

For example, when the information transfer unit 232 judges that the node information satisfies the firing condition, the information transfer unit 232 judges whether or not the node is to fire based on the probability indicated by the firing probability information contained in the node information. Thereafter, when it is judged that the firing condition is satisfied and the node is to fire based on the probability indicated by the firing probability information, the information transfer unit 232 forms and accumulates firing information containing the node identifier contained in the node information.

It is preferable that the information transfer unit 232 changes the processing time for performing information transfer processing in accordance with the temperature information accepted by the temperature acceptance unit 222. For example, when the temperature information indicates a high temperature, the information transfer unit 232 performs information transfer processing more quickly than when the temperature information indicates a lower temperature. For example, when the temperature information indicates a low temperature, the information transfer unit 232 delays information transfer processing compared to when the temperature information indicates a higher temperature. For example, when a delay condition is met, the information transfer unit 232 delays information transfer processing for a predetermined time. Delaying the information transmission processing may be waiting for a predetermined period of time, for example. Note that the delay condition is a condition for delaying processing, and is based on temperature information. The delay condition is, for example, “temperature information<=threshold value” or “temperature information<threshold value”.

It is preferable that the information transfer unit 232 increases the firing probability information contained in the node information regarding the firing node. This is in order to make it easier for the nodes to fire as more nodes fire.

The firing pattern acquisition unit 233 acquires a firing pattern using the one or more node identifiers determined by the information transfer unit 232. The firing pattern is a set of pieces of information that specify one or more firing nodes. A firing pattern is typically information that specifies nodes that fire simultaneously. The firing pattern contains one or more node identifiers.

It is preferable that the firing pattern acquisition unit 233 acquires a firing pattern that contains one or more node identifiers of the one or more nodes that finally fired. The nodes that finally fired are nodes that, among the fired nodes, did not transfer information to other nodes connected by edges.

The output information acquisition unit 234 acquires output information corresponding to the firing pattern acquired by the firing pattern acquisition unit 233. For example, the output information acquisition unit 234 references one or more pieces of output management information stored in the storage unit 21, and acquires output information corresponding to the output condition satisfied by the firing pattern acquired by the firing pattern acquisition unit 233.

For example, the output information acquisition unit 234 references one or more pieces of output management information stored in the storage unit 21, and determines a firing pattern corresponding to the output condition satisfied by the firing pattern acquired by the firing pattern acquisition unit 233. Thereafter, for example, the output information acquisition unit 234 determines whether or not to acquire the output information according to the probability that is based on the output probability information that is paired with the determined firing pattern, and if it is determined to acquire the output information, the output information acquisition unit 234 acquires the output information contained in the output management information.

The output unit 24 outputs various kinds of information. Examples of the various kinds of information include output information.

The information output unit 241 outputs the output information acquired by the output information acquisition unit 234. Here, “output” is a concept that encompasses displaying on a display screen, projection using a projector, printing by a printer, the output of a sound, transmission to an external device, accumulation on a recording medium, delivery of a processing result to another processing device or another program, and the like.

It is preferable that the storage unit 21 and the NN storage unit 113 are realized using a non-volatile recording medium, but they can be realized using a volatile recording medium.

There is no limitation on the process in which information is stored in the storage unit 21 or the like. For example, information may be stored in the storage unit 21 or the like via a recording medium, or information transmitted via a communication line or the like may be stored in the storage unit 21 or the like, or information input via an input device may be stored in the storage unit 21 or the like.

The acceptance unit 22, the information acceptance unit 221, and the temperature acceptance unit 222 can be realized using, for example, a camera, a microphone, a wireless or wired communication means, a broadcast receiving means, a device driver for the input means such as a touch panel or a keyboard, or control software or the like for controlling the menu screen.

The processing unit 23, the feature acquisition unit 231, the information transfer unit 232, the firing pattern acquisition unit 233, and the output information acquisition unit 234 are typically realized using a processor, a memory, and so on. The processing procedures performed by the processing unit 23 and so on are typically realized using software, and the software is recorded on a recording medium such as a ROM. However, such processing procedures may be realized using hardware (a dedicated circuit). Note that the processor may be a CPU, an MPU, a GPU, or the like, and there is no limitation on the type thereof.

The output unit 24 and the information output unit 241 may be regarded as including or not including an output device such as a display or a speaker. The output unit 24 and so on can be realized using the driver software of the output device, the driver software of the output device and the output device, or the like.

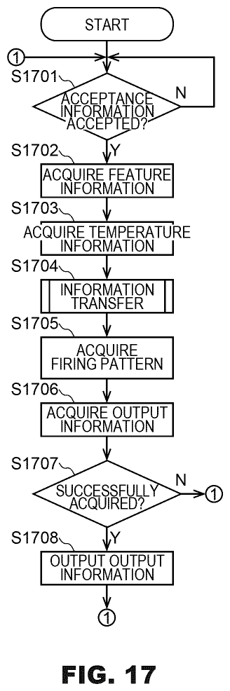

Next, examples of operations of the information processing apparatus 2 will be described with reference to the flowchart in FIG. 17.

(Step S1701) The information acceptance unit 221 judges whether or not acceptance information has been accepted. If acceptance information has been accepted, processing proceeds to step S1702, and if acceptance information has not been accepted, processing returns to step S1701.

(Step S1702) The feature acquisition unit 231 acquires one or more pieces of feature information from the acceptance information accepted in step S1701. For example, the feature acquisition unit 231 acquires one or more pieces of feature information from the image information accepted in step S1701. For example, the feature acquisition unit 231 acquires one or more pieces of feature information from the sound information accepted in step S1701.

(Step S1703) The temperature acceptance unit 222 acquires temperature information.

(Step S1704) The information transfer unit 232 performs information transfer processing within the neural network. An example of information transfer processing will be described with reference to the flowchart in FIG. 15.

(Step S1705) The firing pattern acquisition unit 233 acquires a firing pattern that contains the one or more node identifiers of the one or more nodes that fired last in step S1704. Note that the nodes that fired last are nodes that fired and did not transfer the feature information to other nodes.

(Step S1706) The output information acquisition unit 234 acquires output information corresponding to the firing pattern acquired in step S1705.

(Step S1707) If the output information has been successfully acquired in step S1706, processing proceeds to step S1708, and otherwise processing returns to step S1701.

(Step S1708) The information output unit 241 outputs the information acquired in step S1706. Processing returns to step S1701.

Note that in the flowchart in FIG. 17, the processing unit 23 may include the state determination unit 131 and the growth unit 134 and perform the growth processing described above.

In the flowchart shown in FIG. 17, processing is terminated when power is turned off or an interruption is made to terminate the processing.

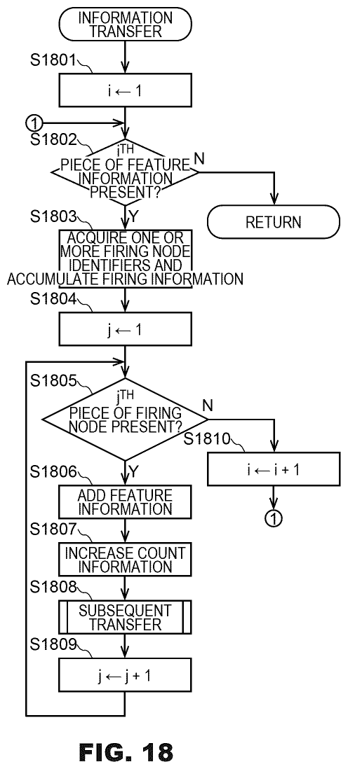

Next, an example of the information transfer processing in step S1704 will be described with reference to the flowchart in FIG. 18.

(Step S1801) The information transfer unit 232 substitutes 1 for the counter i.

(Step S1802) The information transfer unit 232 judges whether or not the i^{th} piece of feature information is present in the pieces of feature information acquired in step S1702. If the i^{th} piece of feature information is present, processing proceeds to step S1803, and otherwise processing returns to higher level processing.

(Step S1803) The information transfer unit 232 references one or more pieces of firing start point information in the storage unit 21, and acquires the one or more node identifiers contained in the one or more pieces of firing start point information satisfied by the i^{th} feature information. The information transfer unit 232 forms firing information that contains the node identifiers, and accumulates it in the storage unit 21. It is preferable that the information transfer unit 232 acquires timer information indicating the points in time of firing from a clock (not shown), forms firing information containing the timer information and the node identifiers, and accumulates it in the storage unit 21. Such one or more node identifiers are the identifiers of the nodes that fire in the first stage. Such node identifiers are firing node identifiers. Here, the information transfer unit 232 does not necessarily have to acquire firing node identifiers.

(Step S1804) The information transfer unit 232 substitutes 1 for the counter j.

(Step S1805) The information transfer unit 232 judges whether or not the j^{th} firing node identifier is present in the firing node identifiers acquired in step S1803. If the j^{th} firing node identifier is present, processing proceeds to step S1806, and otherwise processing proceeds to step S1810.

(Step S1806) The information transfer unit 232 performs processing to add the i^{th} piece of feature information to the node identified by the j^{th} firing node identifier. Note that the processing performed to add the i^{th} piece of feature information to the node is, for example, processing performed to write the i^{th} piece of feature information into the node information regarding the node, or processing performed to associate the i^{th} piece of feature information with the node information regarding the node.

(Step S1807) The information transfer unit 232 performs an update to increase the count information contained in the node information corresponding to the j^{th} firing node identifier. For example, the information transfer unit 232 reads out the count information contained in the node information corresponding to the j^{th} firing node identifier, and overwrites the count information with count information obtained by adding 1 to the count information.

(Step S1808) The information transfer unit 232 performs subsequent transfer processing where the j^{th} firing node identifier is the node-of-interest identifier. An example of subsequent transfer processing will be described with reference to the flowchart in FIG. 16.

Note that the subsequent transfer processing is processing performed to transfer feature information for the node identified by the node-of-interest identifier to a destination node that is connected to the node identified by the node-of-interest identifier via an edge and that is to fire. Note that the processing performed to transfer feature information is information transfer processing.

(Step S1809) The information transfer unit 232 increments the counter j by 1. Processing returns to step S1805.

(Step S1810) The information transfer unit 232 increments the counter i by 1. Processing returns to step S1802.

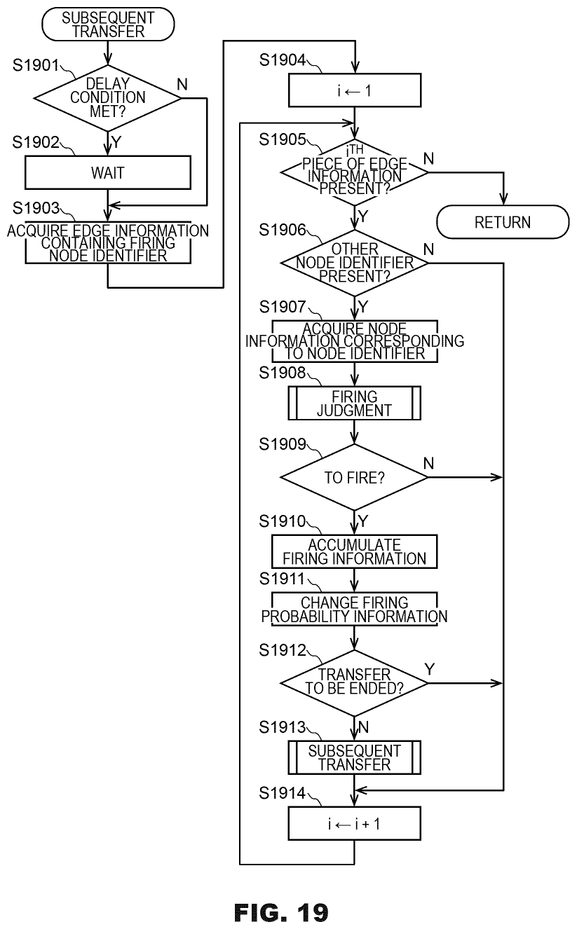

Next, an example of the subsequent transfer processing in step S1808 will be described with reference to the flowchart in FIG. 19.

(Step S1901) The information transfer unit 232 judges whether or not the acquired temperature information matches the delay condition. If the delay condition is met, processing proceeds to step S1902, and if the delay condition is not met, processing proceeds to step S1903.

(Step S1902) The information transfer unit 232 waits. It is preferable that the wait time is determined in advance, but there is no limitation.

(Step S1903) The information transfer unit 232 acquires all the pieces of edge information that contain the firing node identifier of interest from the NN storage unit 113.

(Step S1904) The information transfer unit 232 substitutes 1 for the counter i.

(Step S1905) The information transfer unit 232 judges whether or not the i^{th} piece of edge information is present in the pieces of edge information acquired in step S1901. If the i^{th} piece of edge information is present, processing proceeds to step S1906, and otherwise processing returns to higher level processing.

(Step S1906) The information transfer unit 232 judges whether or not the node identifier of another node is present in the i^{th} edge information. If the node identifier of another node is present, processing proceeds to step S1907, and otherwise processing proceeds to step S1914. Note that the node identifier of another node in the edge information is the node identifier of the connection destination node of the edge. The case where the node identifier of another node is present in the i^{th} edge information is the case where the edge is connected to two nodes.

(Step S1907) The information transfer unit 232 acquires the node identifier of the other node in the i^{th} piece of edge information. Next, the information transfer unit 232 acquires, from the NN storage unit 113, the node information regarding the node identified by the node identifier.

(Step S1908) Using the node information acquired in step S1907, the information transfer unit 232 judges whether or not the node corresponding to the node information fires. An example of such firing judgment processing will be described with reference to the flowchart in FIG. 17.

(Step S1909) If the judgment result in step S1908 is “fire”, the information transfer unit 232 proceeds to step S1910, and if the judgment result is “not fire”, the information transfer unit 232 proceeds to step S1914.

(Step S1910) The information transfer unit 232 acquires firing information that contains the node identifier contained in the node information acquired in step S1907, and accumulates the firing information in the storage unit 11.

(Step S1911) The information transfer unit 232 changes the firing probability information contained in the node information acquired in step S1907. Here, the information transfer unit 232 changes the firing probability information so that the firing probability specified by the firing probability information increases.

(Step S1912) The information transfer unit 232 judges whether or not to end the transfer of information between the nodes. If the transfer is to be ended, processing proceeds to step S1914, and if the transfer is not to be ended, processing proceeds to step S1913. Note that when the transfer is to be ended is, for example, when the node is a terminal node in the NN. In addition, when the transfer is to be ended, the node identifiers contained in the firing information accumulated immediately before in step S1910 are the node identifiers to be included in the firing pattern.

(Step S1913) The information transfer unit 232 performs subsequent transfer processing where the node is the node of interest. An example of subsequent transfer processing is shown in FIG. 16.

(Step S1914) The information transfer unit 232 increments the counter i by 1. Processing returns to step S1905.

In the flowchart in FIG. 19, it is preferable that, when transferring information between nodes, the information transfer unit 232 updates the retained energy amount information to one that has been obtained by reducing the amount of energy indicated by the retained energy amount information contained in the firing origin node information. The same may also be applied to the retained energy amount information that is paired with the axon identifier of the axon used for the transfer, and the retained energy amount information that is paired with the dendrite identifier of the dendrite used for the transfer. In addition, it is assumed that the function for reducing the amount of energy is stored in the storage unit 21, for example. There is no limitation on the function. The function is a well-known technique, and therefore a detailed description will be omitted.

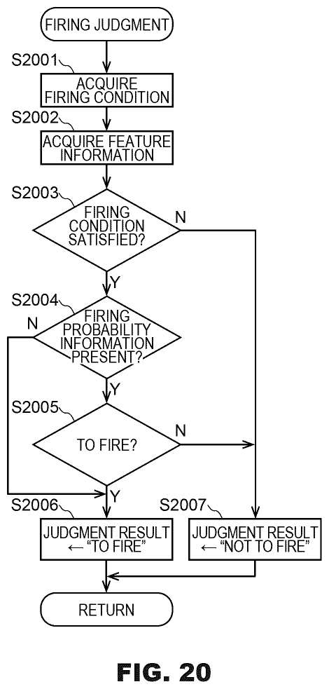

Next, an example of the firing judgment processing in step S1908 will be described with reference to the flowchart in FIG. 20.

(Step S2001) The information transfer unit 232 acquires a firing condition corresponding to the node information acquired in step S1905. Note that the firing condition may be different for each node, or may be common to two or more nodes.

(Step S2002) The information transfer unit 232 acquires one or more pieces of feature information. Note that the one or more pieces of feature information here are pieces of feature information transferred from the firing origin node.

(Step S2003) The information transfer unit 232 judges whether or not the one or more pieces of feature information acquired in step S2002 satisfy the firing condition acquired in step S2001. If the firing condition is satisfied, processing proceeds to step S2004, and if the firing condition is not satisfied, processing proceeds to step S2007.

(Step S2004) The information transfer unit 232 judges whether or not the node information of interest contains firing probability information. If the firing probability information is contained, processing proceeds to step S2005, and if firing probability information is not contained, processing proceeds to step S2006.

(Step S2005) The information transfer unit 232 acquires the firing probability information contained in the node information of interest. Next, using the firing probability information, the information transfer unit 232 judges whether or not the node is to fire. If the node is to fire, processing proceeds to step S2006, and if the node is not to fire, processing proceeds to step S2007.

(Step S2006) The information transfer unit 232 substitutes “to fire” for the judgment result. Processing returns to higher level processing.

(Step S2007) The information transfer unit 232 substitutes “not to fire” for the judgment result. Processing returns to higher level processing.

As described above, with the present embodiment, it is possible to simulate the operation of the grown brain of an infant.

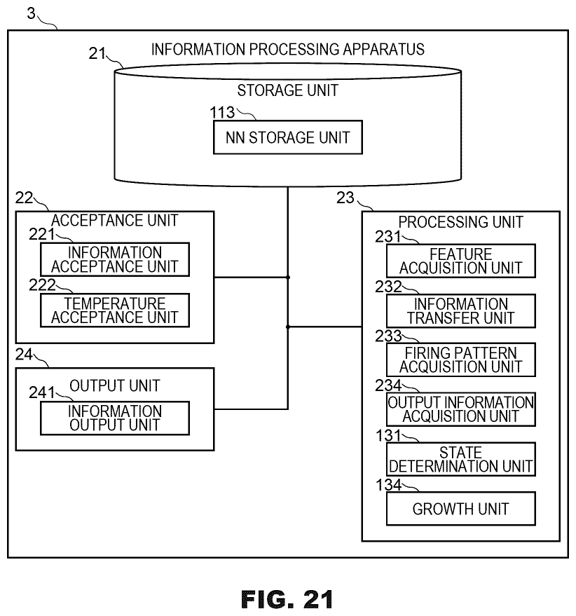

Note that in the present embodiment, the information processing apparatus may realize the growth processing performed by the NN growth apparatus 1. In this case, the information processing apparatus can output output information corresponding to the accepted acceptance information while growing the neural network. The information processing apparatus in such a case is an information processing apparatus 3. The information processing apparatus 3 includes the state determination unit 131 and the growth unit 134 included in the NN growth apparatus 1 in addition to the components of the information processing apparatus 2. A block diagram for the information processing apparatus 3 in such a case is shown in FIG. 21.

In FIG. 21, the processing performed by the firing node determination unit 133 of the NN growth apparatus is performed by the information transfer unit 232. The feature acquisition unit 231 is the same as the feature acquisition unit 132.

The software that realizes the information processing apparatus 2 according to the present embodiment is the program described below. That is to say, this program is a program that enables a computer that can access an NN storage unit in which neural network information accumulated by an NN growth apparatus 1 is stored, to function as: an information acceptance unit that accepts acceptance information that is at least one of image information and sound information; a feature acquisition unit that acquires one or more pieces of feature information corresponding to the acceptance information accepted by the information acceptance unit; an information transfer unit that determines one or more node identifiers of one or more firing nodes, corresponding to the one or more pieces of feature information acquired by the feature acquisition unit, from a start point storage unit in which one or more pieces of firing start point information are stored, each piece of firing start point information containing an information identifier that identifies feature information of acceptance information and one or more node identifiers that identify nodes that initially fire when the feature information is accepted, and determines a node identifier of a firing node that is connected to the one or more nodes identified by the one or more node identifiers by edges and to which the feature information is to be transferred; a firing pattern acquisition unit that acquires a firing pattern using the one or more node identifiers determined by the information transfer unit; an output information acquisition unit that acquires output information corresponding to the firing pattern acquired by the firing pattern acquisition unit; and an information output unit that outputs the output information.

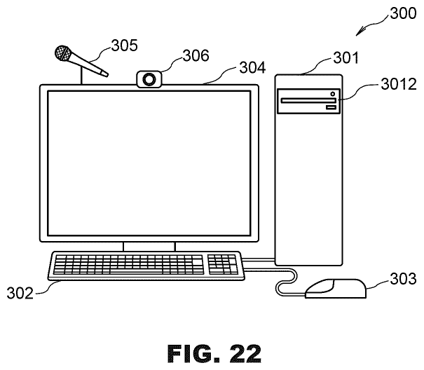

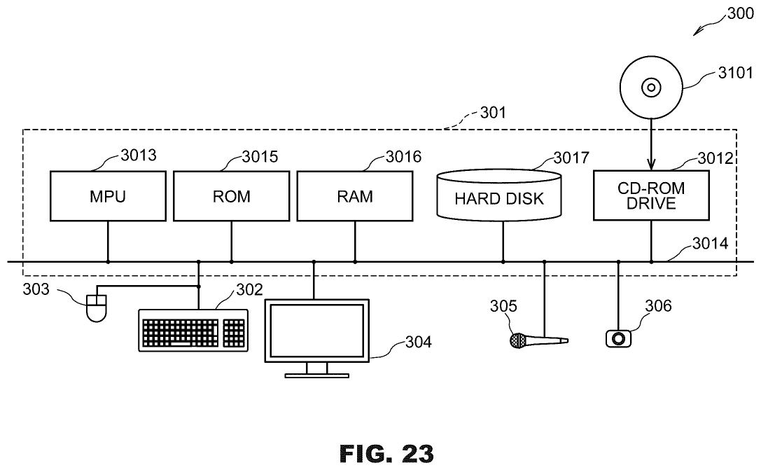

FIG. 22 shows an external appearance of a computer that executes the program described in the present description and realizes the NN growth apparatus 1, the information processing apparatus 2 and the information processing apparatus 3 according to the various embodiments described above. The above-described embodiments can be realized using computer hardware and a computer program executed thereon. FIG. 22 is an overview diagram for this computer system 300, and FIG. 23 is a block diagram for the system 300.

In FIG. 22, the computer system 300 includes a computer 301 that includes a CD-ROM drive, a keyboard 302, a mouse 303, a monitor 304, a microphone 305, and a camera 306.

In FIG. 23, the computer 301 includes, in addition to the CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the figure, the computer 301 may further include a network card that provides connection to a LAN.

The program that enables the computer system 300 to perform the functions of the NN growth apparatus 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third party program, or the like that enables the computer 301 to perform the functions of the NN growth apparatus 1 and so on according to the embodiments described above. The program need only contain the part of the instruction that calls an appropriate function (module) in a controlled manner to achieve a desired result. How the computer system 300 works is well known and the detailed descriptions thereof will be omitted.

In the above-described program, the step of transmitting information, the step of receiving information and so on do not include processing performed by hardware, for example, processing performed by a modem or an interface card in the step of transmitting (processing that can only be performed by hardware).

There may be a single or multiple computers executing the above-described program. That is to say, centralized processing or distributed processing may be performed.

Also, as a matter of course, in each of the above-described embodiments, two or more communication means that are present in one device may be physically realized using one medium.

Also, in the above-described embodiments, each kind of processing may be realized as centralized processing that is performed by a single device, or distributed processing that is performed by multiple devices.

As a matter of course, the present invention is not limited to the above-described embodiments, and various changes are possible, and such variations are also included within the scope of the present invention.

### Industrial Applicability

As described above, the NN growth apparatus according to the present invention has the effect of being able to simulate infant brain growth, and is useful as an NN growth apparatus or the like.

1. An NN growth apparatus comprising:
an NN storage unit in which neural network information is stored, the neural network information containing two or more pieces of node information each containing a node identifier, and one or more pieces of edge information each containing an edge identifier and specifying a connection between nodes;
a start point storage unit in which one or more pieces of firing start point information are stored, each piece of firing start point information containing an information identifier that identifies feature information of image information and one or more node identifiers that identify nodes that initially fire when the feature information is accepted;
a goal storage unit in which pieces of goal information are stored, the pieces of goal information specifying goals respectively corresponding to two or more states that include positive and negative states;
an information acceptance unit that accepts image information and sound information;
a state determination unit that determines one state from among the two or more states, using the sound information accepted by the information acceptance unit;
a feature acquisition unit that acquires, using the image information accepted by the information acceptance unit, one or more pieces of feature information corresponding to the image information;
a firing node determination unit that determines one or more node identifiers of one or more firing nodes corresponding to the one or more pieces of feature information acquired by the feature acquisition unit, from the start point storage unit, and determines a node identifier of a firing node that is connected to the one or more nodes identified by the one or more node identifiers by edges and to which the feature information is to be transferred; and
a growth unit that acquires the goal information paired with the one state determined by the state determination unit, and, using the goal information, performs processing to grow node information or edge information corresponding to one or more node identifiers of the one or more node identifiers determined by the firing node determination unit.

2. The NN growth apparatus according to claim 1, further comprising:
a window determination unit that sequentially determines, from a still image contained in the image information accepted by the information acceptance unit, a sliding window, which is a partial region of the still image,
wherein the feature acquisition unit uses a partial image corresponding to the sliding window sequentially determined by the window determination unit, to acquire one or more pieces of feature information corresponding to the partial image.

3. The NN growth apparatus according to claim 1,
wherein the feature information contains an information identifier that identifies information and an information amount that indicates a size of the information, and
the firing node determination unit judges whether or not one or more pieces of feature information transferred from one or more other nodes connected by edges satisfy one or more firing conditions related to the feature information, and determines the node identifier of a node judged to satisfy the firing conditions.

4. The NN growth apparatus according to claim 1,
wherein the node information contains node position information that specifies a position of the node,
the goal information contains goal position information that specifies a position of the goal, or goal direction information that indicates a direction of the goal, and
the growth unit performs edge generation processing to generate and accumulate edge information for an edge extending from one or more nodes identified by one or more node identifiers among the one or more node identifiers determined by the firing node determination unit in the direction indicated by the goal information that is paired with the one state determined by the state determination unit.

5. The NN growth apparatus according to claim 4,
wherein the firing node determination unit accumulates count information related to a count of the determined node identifiers in association with the node identifiers, and
the growth unit performs the edge generation processing on a node identified by a node identifier corresponding to the count information that matches an edge generation condition.

6. The NN growth apparatus according to claim 1,
wherein the node information contains node position information that specifies a position of the node,
the goal information contains goal position information that specifies a position of the goal, or goal direction information that indicates a direction of the goal, and
the growth unit performs edge growth processing to acquire and accumulate edge information in which an edge extending from one or more nodes identified by one or more node identifiers among the one or more node identifiers determined by the firing node determination unit is grown in a direction indicated by the goal information paired with the one state determined by the state determination unit.

7. The NN growth apparatus according to claim 6,
wherein the firing node determination unit accumulates count information related to a count of the determined node identifiers in association with the node identifiers, and
the growth unit performs the edge growth processing on a node identified by a node identifier corresponding to the count information that matches an edge generation condition.

8. The NN growth apparatus according to claim 1,
wherein each node is a soma,
the edges include an axon and a dendrite, and
the edge information contains axon information that contains an axon identifier and axon position information indicating a position of the axon, and dendrite information that contains a dendrite identifier and dendrite position information indicating a position of the dendrite.

9. An information processing apparatus comprising:
an NN storage unit in which neural network information accumulated by the NN growth apparatus according to claim 1 is stored;
an information acceptance unit that accepts acceptance information that is at least one of image information and sound information;
a feature acquisition unit that acquires one or more pieces of feature information corresponding to the acceptance information accepted by the information acceptance unit;
an information transfer unit that determines one or more node identifiers of one or more firing nodes, corresponding to the one or more pieces of feature information acquired by the feature acquisition unit, from a start point storage unit in which one or more pieces of firing start point information are stored, each piece of firing start point information containing an information identifier that identifies feature information of acceptance information and one or more node identifiers that identify nodes that initially fire when the feature information is accepted, and determines a node identifier of a firing node that is connected to the one or more nodes identified by the one or more node identifiers by edges and to which the feature information is to be transferred;
a firing pattern acquisition unit that acquires a firing pattern using the one or more node identifiers determined by the information transfer unit;
an output information acquisition unit that acquires output information corresponding to the firing pattern acquired by the firing pattern acquisition unit; and
an information output unit that outputs the output information.

10. The information processing apparatus according to claim 8, further comprising:
a temperature acceptance unit that accepts temperature information,
wherein the information transfer unit performs information transfer processing to transfer, from a node that has fired, the feature information corresponding to the node that has fired, to a node that is to fire next, and changes a processing time for the information transfer processing based on the temperature information accepted by the temperature acceptance unit.

11. A method for producing neural network information realized by: an NN storage unit in which neural network information is stored, the neural network information containing two or more pieces of node information each containing a node identifier, and one or more pieces of edge information each containing an edge identifier and specifying a connection between nodes; a start point storage unit in which one or more pieces of firing start point information are stored, each piece of firing start point information containing an information identifier that identifies feature information of image information and one or more node identifiers that identify nodes that initially fire when the feature information is accepted; a goal storage unit in which pieces of goal information are stored, the pieces of goal information specifying goals respectively corresponding to two or more states that include positive and negative states; an information acceptance unit, a state determination unit, a feature acquisition unit, a firing node determination unit, and a growth unit, the method comprising:
an information acceptance step in which the information acceptance unit accepts image information and sound information;
a state determination step in which the state determination unit determines one state from among the two or more states, using the sound information accepted in the information acceptance step;
a feature acquisition step in which the feature acquisition unit acquires, using the image information accepted in the information acceptance step, one or more pieces of feature information corresponding to the image information;
a firing node determination step in which the firing node determination unit determines one or more node identifiers of one or more firing nodes corresponding to the one or more pieces of feature information acquired in the feature acquisition step, from the start point storage unit, and determines a node identifier of a firing node that is connected to the one or more nodes identified by the one or more node identifiers by edges and to which the feature information is to be transferred; and
a growth step in which the growth unit acquires the goal information paired with the one state determined by the state determination unit, and, using the goal information, performs processing to grow node information or edge information corresponding to one or more node identifiers of the one or more node identifiers determined by the firing node determination unit.

12. A program that enables a computer that can access: an NN storage unit in which neural network information is stored, the neural network information containing two or more pieces of node information each containing a node identifier, and one or more pieces of edge information each containing an edge identifier and specifying a connection between nodes; a start point storage unit in which one or more pieces of firing start point information are stored, each piece of firing start point information containing an information identifier that identifies feature information of image information and one or more node identifiers that identify nodes that initially fire when the feature information is accepted; and a goal storage unit in which pieces of goal information are stored, the pieces of goal information specifying goals respectively corresponding to two or more states that include positive and negative states, to function as:
an information acceptance unit that accepts image information and sound information;
a state determination unit that determines one state from among the two or more states, using the sound information accepted by the information acceptance unit;
a feature acquisition unit that acquires, using the image information accepted by the information acceptance unit, one or more pieces of feature information corresponding to the image information;
a firing node determination unit that determines one or more node identifiers of one or more firing nodes corresponding to the one or more pieces of feature information acquired by the feature acquisition unit, from the start point storage unit, and determines a node identifier of a firing node that is connected to the one or more nodes identified by the one or more node identifiers by edges and to which the feature information is to be transferred; and
a growth unit that acquires the goal information paired with the one state determined by the state determination unit, and, using the goal information, performs processing to grow node information or edge information corresponding to one or more node identifiers of the one or more node identifiers determined by the firing node determination unit.
